(19) United States
(12) Patent Application Publication
(10) Pub. No.: US 2023/0074386 A1
(43) Pub. Date: Mar. 9, 2023

(54) METHOD AND APPARATUS FOR PERFORMING IDENTITY RECOGNITION ON TO-BE-RECOGNIZED OBJECT, DEVICE AND MEDIUM

(71) Applicant: Moqi Technology (Beijing) Co., Ltd., Beijing (CN)

(72) Inventors: Xiaohua ZHANG, Beijing (CN); Lintao GUO, Beijing (CN); Hao YANG, Beijing (CN); Qingdi ZHANG, Beijing (CN); Xuemei WANG, Beijing (CN); Zhiwei ZHANG, Beijing (CN); Hanwen LIU, Beijing (CN); Dongquan SU, Beijing (CN); Fangrui LIU, Beijing (CN); Xinan WANG, Beijing (CN); Linpeng TANG, Beijing (CN); Cheng TAI, Beijing (CN)

(73) Assignee: Moqi Technology (Beijing) Co., Ltd., Beijing (CN)

(21) Appl. No.: 17/903,803

(22) Filed: Sep. 6, 2022

(30) Foreign Application Priority Data
Sep. 7, 2021 (CN) 202111045195.8
Sep. 15, 2021 (CN) 202111082363.0
Jul. 1, 2022 (CN) 202210775288.4
Aug. 26, 2022 (CN) 202211033914.9

(51) Int. Cl. G06V 40/12; H04N 5/232; H04N 5/33

(52) U.S. Cl. CPC G06V 40/1365; G06V 40/1347; H04N 5/23218; H04N 5/23241; H04N 5/33

(57) ABSTRACT

The present disclosure provides a method for performing identity recognition on a to-be-recognized object, an electronic device, and a non-transitory computer-readable storage medium. The method includes: acquiring, by the infrared camera, and in response to an infrared camera turn-on condition being met, a first image of a to-be-recognized target, and performing target detection on the first image, the to-be-recognized target being a finger and/or a palm; acquiring, by the visible light camera, and in response to a visible light camera turn-on condition being met, a second image of the to-be-recognized target, and performing identifier code recognition on the second image; performing, in response to the to-be-recognized target being detected from the first image, identity recognition based on a third image, and determining an identity recognition result of the to-be-recognized object, the third image being at least one image among the first image in which the to-be-recognized target is detected.

### RELATED APPLICATIONS

This application claims priority to Chinese Patent Application No. CN202111045195.8 filed on Sep. 7, 2021; Chinese Patent Application No. CN202111082363.0 filed on Sep. 15, 2021; Chinese Patent Application No. CN202210775288.4 filed on Jul. 1, 2022; and Chinese Patent Application No. CN202211033914.9 filed on Aug. 26, 2022, all of which is hereby incorporated by reference in its entirety and for all purposes.

### TECHNICAL FIELD

The present disclosure relates to a field of computer vision technology, and more particularly, to a method and an apparatus for performing identity recognition on a to-be-recognized object, an electronic device, and a computer-readable storage medium.

### BACKGROUND

With development of artificial intelligence, identity authentication technologies relying on biometric features have been widely applied in recent years, especially development of face recognition is the most rapid; there are numerous application scenarios, for example, identity card-face verification, gate pass, and offline payment, etc. Meanwhile, identity authentication technologies based on finger and palm features are gradually being applied, for example, a user's identity may be recognized by recognizing palm print or palm vein information on the user's palm.

The methods as described in the section are not necessarily methods that have been previously conceived or adopted. Unless otherwise indicated, it should not be assumed that any of the methods as described in the section qualify as prior art merely by virtue of their inclusion in the section. Similarly, unless otherwise indicated, the problems raised in the section should not be considered to be generally acknowledged in any prior art.

### SUMMARY

The present disclosure provides a method and an apparatus for performing identity recognition on a to-be-recognized object, an electronic device, and a computer-readable storage medium.

According to an aspect of the present disclosure, a method for performing identity recognition on a to-be-recognized object is provided and applied to an electronic device, the electronic device comprises an infrared camera and a visible light camera, and the method comprises: acquiring, by the infrared camera, and in response to an infrared camera turn-on condition being met, a first image of a to-be-recognized target, and performing target detection on the first image, the to-be-recognized target being a finger and/or a palm; acquiring, by the visible light camera, and in response to a visible light camera turn-on condition being met, a second image of the to-be-recognized target, and performing identifier code recognition on the second image; performing, in response to the to-be-recognized target being detected from the first image, identity recognition based on a third image, and determining an identity recognition result of the to-be-recognized object, the third image being at least one image among the first image in which the to-be-recognized target is detected, and the identity recognition result determined based on the third image comprising a candidate object in a candidate database matching the to-be-recognized object; and determining, in response to the identifier code being recognized, and according to an identifier code recognition result, the identity recognition result of the to-be-recognized object, and turning off at least one camera in an ON state, in which the to-be-recognized target is a hand or an identifier code of the to-be-recognized object.

According to another aspect of the present disclosure, an electronic device is provided, and the electronic device comprises at least one processor and a memory communicatively connected to the at least one processor; the memory stores instructions executable by the at least one processor, and the instructions are capable of being executed by the at least one processor to enable the at least one processor to execute the above-mentioned method for performing identity recognition on a to-be-recognized object.

According to another aspect of the present disclosure, a non-transitory computer-readable storage medium storing computer instructions is provided, and the computer instructions are configured to cause a computer to execute the above-mentioned method for performing identity recognition on a to-be-recognized object.

### BRIEF DESCRIPTION OF THE DRAWINGS

The drawings exemplarily show embodiments and form part of the specification, and are used to explain exemplary implementations of the embodiments together with the textual description of the specification. The embodiments shown are for illustrative purposes only and do not limit the scope of the claims. In all the drawings, identical reference numerals refer to similar but not necessarily identical elements.

FIG. 1 shows a flow chart of a method for performing identity recognition on a to-be-recognized object according to at least one embodiment of the present disclosure;

FIG. 2A-FIG. 2C show a timing of image capture, identifier code recognition, and target detection performed by a visible light camera and an infrared camera according to an embodiment of the present disclosure;

FIG. 3A-FIG. 3C show a timing of image capture, identifier code recognition, and target detection performed by a visible light camera and an infrared camera according to another embodiment of the present disclosure;

FIG. 4 shows a schematic diagram of an output result of a hand detecting neural network according to at least one embodiment of the present disclosure;

FIG. 5 shows a schematic diagram of a to-be-recognized feature image according to at least one embodiment of the present disclosure; and

FIG. 6 shows a structural block diagram of an exemplary electronic device capable of implementing the embodiments of the present disclosure.

### DETAILED DESCRIPTION

Exemplary embodiments of the present disclosure will be described below in conjunction with the drawings, and various details of the embodiments of the present disclosure are included to facilitate understanding and should be considered as exemplary only. Accordingly, those ordinarily skilled in the art will recognize that various changes and modifications of the embodiments described herein may be made without departing from the scope of the present disclosure. Likewise, descriptions of well-known functions and constructions are omitted from the following description for clarity and conciseness.

In the present disclosure, unless otherwise specified, the use of the terms “first,” “second,” etc. to describe various elements is not intended to limit positional relationship, timing relationship or importance relationship of these elements, and such terms are only used for distinguish one element from another. In some examples, a first element and a second element may refer to a same instance of the element; while in some cases, they may also refer to different instances based on the context of the description.

The terms used in the description of various examples in the present disclosure is for the purpose of describing particular examples only and is not intended to be limitative. Unless otherwise clearly dictated by the context, if the number of an element is not expressly limited, the element may be one or more. Furthermore, as used in the present disclosure, the term “and/or” covers any and all possible combinations of the listed items.

The applicant finds that, an identity recognition technology is compatible with biometric feature-based identity recognition and identifier code-based identity recognition, for example, biometric feature-based identity recognition is performed on a registered user and identifier code-based identity recognition is performed on an unregistered user; and the registered user is allowed for biometric feature-based identity recognition or identifier code-based identity recognition, etc. In the case that the identity recognition technology is applied to an edge device or a terminal device, it is usually required that power consumption and heat generation of the device should not be too high, otherwise, it is difficult to ensure long-term stable operation of the device. Some authentication technologies do not optimize an operation timing of respective components when performing biometric feature-based identity recognition and identifier code-based identity recognition, and it is difficult to take into account both high recognition speed and low power consumption of identity recognition.

The identity recognizing method provided by the embodiment of the present disclosure is configured on an electronic device provided by at least one embodiment of the present disclosure. The electronic device may be an edge device, a terminal device, etc., the electronic device is, for example, a palm print and palm vein recognizing instrument compatible with identifier code recognition and card recognition, and the electronic device includes an infrared camera and a visible light camera.

The identity recognizing method according to the present disclosure will be further described below in conjunction with the drawings.

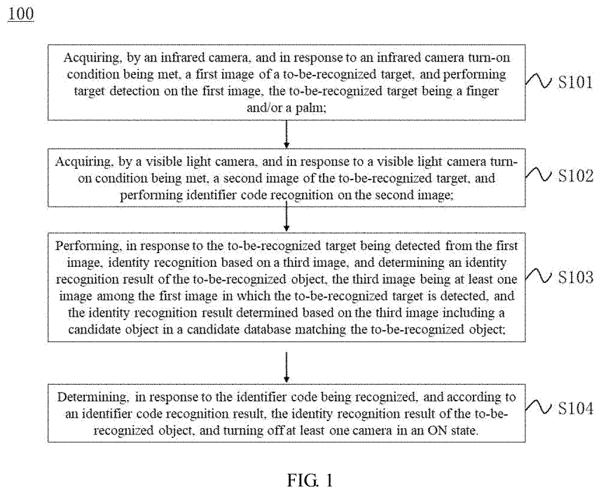

FIG. 1 shows a flow chart of a method for performing identity recognition on a to-be-recognized object according to an exemplary embodiment of the present disclosure.

As shown in FIG. 1, the method 100 includes the following steps.

Step S101: acquiring, by an infrared camera, and in response to an infrared camera turn-on condition being met, a first image of a to-be-recognized target, and performing target detection on the first image, the to-be-recognized target being a finger and/or a palm.

Step S102: acquiring, by a visible light camera, and in response to a visible light camera turn-on condition being met, a second image of the to-be-recognized target, and performing identifier code recognition on the second image.

The to-be-recognized target is a hand or an identifier code of the to-be-recognized object. In the present disclosure, identity recognition of the to-be-recognized object may rely on the hand or the identifier code, for example, hand-based identity recognition is performed on a registered user, identifier code-based identity recognition is performed on an unregistered user; for example, the registered user is allowed to pay by swiping palm or swiping code. Therefore, the to-be-recognized target may be the hand stretched by the to-be-recognized object or the identifier code provided by the to-be-recognized object and displayed on a medium such as a mobile device or paper.

The acquiring the first image and performing target detection, and acquiring the second image and performing identifier code recognition may be performed continuously while the corresponding camera is in an ON state. The camera continuously captures images when it is turned on, and the electronic device continuously performs target detection and identifier code recognition on the captured images, until the camera receives an OFF instruction and stops capturing images. The cases that the camera receives the OFF instruction and stops capturing images may include that: an image for identity recognition has been captured or an identity recognition end condition is met. The identity recognition end condition may include at least one selected from a group consisting of: a candidate object matching the to-be-recognized object is determined through identity recognition, time consumption of the current round of identity recognition reaches a preset duration, and the number of times of the current round of identity recognition reaches a preset number of times.

In one example, target detection on the first image, that is, the infrared image, is performed through a neural network model. It may be understood that, usually, the neural network model requires a large amount of computation and consumes greater power, while the identifier code recognition requires a small amount of computation and consumes less power. If target detection is performed simultaneously on the infrared image and the visible light image, a target detection algorithm for target detection on the visible light image and a target detection algorithm for target detection on the infrared image may need to be run simultaneously, which consumes a lot of computing power, correspondingly increasing power consumption and heat generation.

The inventor(s) of the present disclosure finds that, in the case that the to-be-recognized target is an identifier code, the identifier code may be recognized in the visible light image containing the to-be-recognized target, but the identifier code is hard to be recognized in the infrared image containing the to-be-recognized target; in the case that the to-be-recognized target is a hand, in a case of proper exposure, the hand may be detected in both the visible light image and the infrared image containing the to-be-recognized target.

Based on the above-mentioned characteristic and taking into account the computation amount required for both target detection and identifier code recognition, the embodiments of the present disclosure use the visible light image for identifier code recognition and the infrared image for target detection, so that it may be determined as early as possible whether the to-be-recognized target is the hand or the identifier code of the to-be-recognized object, so as to improve the recognition speed; in addition, the corresponding camera is only turned on when necessary, and turned off during other time, so as to save computing power and reduce power consumption, so that in the case where the embodiments of the present disclosure support identity recognition based on the biometric features and the identifier code captured by a visible light and infrared dual-camera, high identity recognition speed and low power consumption may both be taken into account.

Step S103: performing, in response to the to-be-recognized target being detected from the first image, identity recognition based on a third image, and determining an identity recognition result of the to-be-recognized object, the third image being at least one image among the first image in which the to-be-recognized target is detected, and the identity recognition result determined based on the third image including a candidate object in a candidate database matching the to-be-recognized object.

In response to the to-be-recognized target being detected from the first image, the third image is determined from the first image in which the to-be-recognized target is detected, and then identity recognition is performed based on the third image. In one example, the first image in which the to-be-recognized target is detected is directly used as the third image. In another example, quality detection may be performed on the first image in which the to-be-recognized target is detected, and the first image sufficiently qualified is used as the third image.

The third image may be one or more images, for example, a first image in which the to-be-recognized target is detected is used as the third image, or a plurality of qualified first images in which the to-be-recognized target is detected are used as the third image. Identity recognition based on the third image may be performed based on one third image firstly, and identity recognition is performed again based on another third image in the case where no candidate object matching the to-be-recognized object is recognized. The another third image may be captured successive to the previous third image, or may also be captured again when no candidate object matching the to-be-recognized object is recognized based on one third image.

In one example, after the third image is determined, an OFF instruction is sent to the camera, which, thence, no longer continues to capture images, and the captured third image may be used for subsequent identity recognition. In another example, after the third image is determined, the camera is still kept on, and after the identity recognition end condition is met, the camera is turned off to stop image capture, so that in the case where no candidate object matching the to-be-recognized object is recognized based on one third image, the camera may re-capture images. The identity recognition end condition may include at least one selected from a group consisting of: a candidate object matching the to-be-recognized object is determined through identity recognition, time consumption of the current round of identity recognition reaches a preset duration, and the number of the current round of identity recognitions reaches a preset number of times. For example, if no candidate object matching the to-be-recognized object is recognized, identity recognition is performed again based on other third images, then the number of identity recognitions of the current round is increased by 1, and the sum of time consumption of the respective times is counted as time consumption of identity recognition.

In one example, the identity recognition result determined based on the third image may include whether there is a candidate object matching the to-be-recognized object in the candidate database, and which candidate object is the candidate object matching the to-be-recognized object. It may be understood that, the identity may not only refer to personal information such as name and ID, but also may refer to any identifier indicating a candidate object.

It may be understood that, identity recognition based on the third image may be: determining a feature of the to-be-recognized object based on the third image, acquiring a feature of the candidate object from the candidate database, comparing the feature of the to-be-recognized object with the feature of the candidate object, and determining the identity recognition result according to a similarity obtained from comparison.

Step S104: determining, in response to the identifier code being recognized, and according to an identifier code recognition result, the identity recognition result of the to-be-recognized object, and turning off at least one camera in an ON state.

It may be understood that, the identifier code may be, for example, but not limited to, a two-dimensional code, or for example, may also be a barcode, etc.

The identifier code may be in a one-to-one correspondence with the identity. For example, an identifier code is provided for a visitor; if the identifier code is recognized, the identity recognition result of the to-be-recognized object may be directly determined according to the identifier code recognition result.

The correspondence between the identifier code and the identity may be recorded in the candidate database; for example, each candidate object in the candidate database not only corresponds to a candidate feature, but also corresponds to an identifier code. The identifier code may also be recorded in a database other than the candidate database; for example, the candidate objects in the candidate database are all registered objects, and candidate features thereof are extracted during registration; unregistered objects such as visitors may apply for permission from an identity recognizing system in advance and be assigned with an identifier code by the identity recognizing system, and the identifier code of the unregistered object is recorded in an unregistered object database different from the candidate database.

In response to the identifier code being recognized, and according to the identifier code recognition result, the identity of the to-be-recognized object may already be determined; at this time, there is no need to continue capturing images, the at least one camera in an ON state may be turned off and corresponding target detection and identifier code recognition may be stopped. If only the visible light camera is in an ON state, the visible light camera is turned off; if both the visible light camera and the infrared camera are in an ON state, the visible light camera and the infrared camera are turned off, which, thus, may further save computing power and reduce power consumption.

Exemplarily, the flow of identifier code recognition and determining the identity recognition result of the to-be-recognized object according to the identifier code recognition result may include: detecting an identifier code image from the second image, performing perspective transformation on the identifier code image through OpenCV, extracting coding information from the identifier code after perspective transformation to acquire a corresponding ID, and acquiring identity information corresponding to the ID from an ID-identity database according to the ID.

After the identity recognition result of the to-be-recognized object is determined based on the third image or the identifier code recognition result, it may be judged whether to perform subsequent operations according to the identity recognition result, for example, whether to open access control, whether to open authority of obtaining certain information for the to-be-recognized object, etc.

It may be understood that, steps 101 to 104 are only serial numbers, and do not limit sequence of the steps.

In the embodiments of the present disclosure, the characteristic is fully used that in the case where the to-be-recognized target is an identifier code, the identifier code may be recognized by the visible light image containing the to-be-recognized target, and in the case where the to-be-recognized object is a hand, the hand may be detected by both the visible light image and the infrared image containing the to-be-recognized target; meanwhile, taking into account the computation amount required for both target detection and identifier code recognition, visible light images is used for identifier code recognition and infrared images is used for target detection; in addition, because the corresponding camera is only turned on when necessary, in the case where identity recognition based on the biometric features and the identifier code captured by a visible light and infrared dual-camera is supported, high identity recognition speed and low power consumption may both be taken into account.

According to some embodiments, the electronic device further includes a card reader module, and the identity recognizing method 100 further includes:

Step 105: determining, in response to the card reader module detecting a card signal of the to-be-recognized object, and according to the card signal, the identity recognition result of the to-be-recognized object, and turning off the at least one camera in an ON state.

In one example, the electronic device configured with the identity recognizing method may support not only biometric feature-based identity recognition and identifier code-based identity recognition, but also card-based identity recognition. When the card reader module detects the card signal, the identity of the to-be-recognized object may be determined just by using the card signal, without further capturing an image for identity recognition; at this time, all cameras in an ON state may be turned off to reduce power consumption.

The card reader module may be an NFC module, a radio frequency module, etc. The card reader module may be always in an ON state, or may also be in an OFF state and turned on in response to a card reader turn-on condition being met. The card reader turn-on condition may be the same as the infrared camera and/or visible light camera turn-on condition. For example, the electronic device further includes a distance sensor, and in response to the distance sensor detecting the to-be-recognized target, the card reader module is turned on.

In this way, this embodiment can take into account both high recognition speed and low power consumption of identity recognition in the case of supporting identity recognition based on the biometric features, the identifier code, and the card signal captured by the visible light and infrared dual-camera.

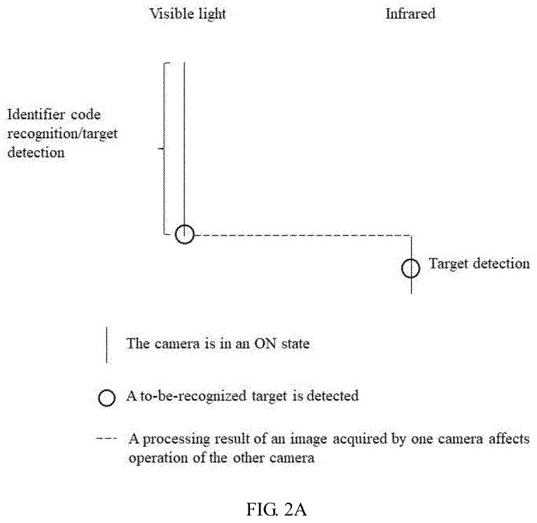

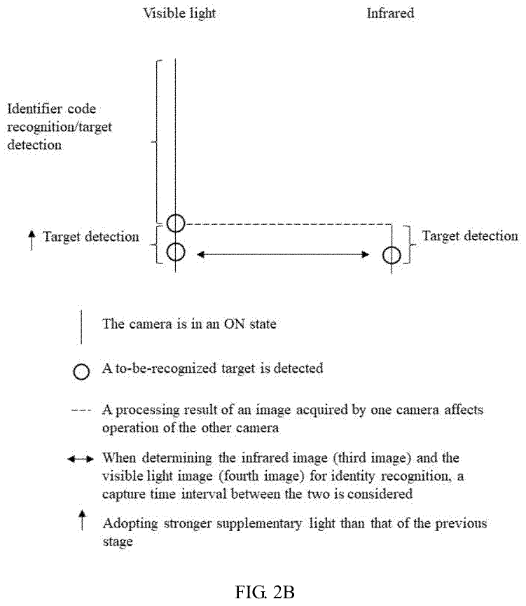

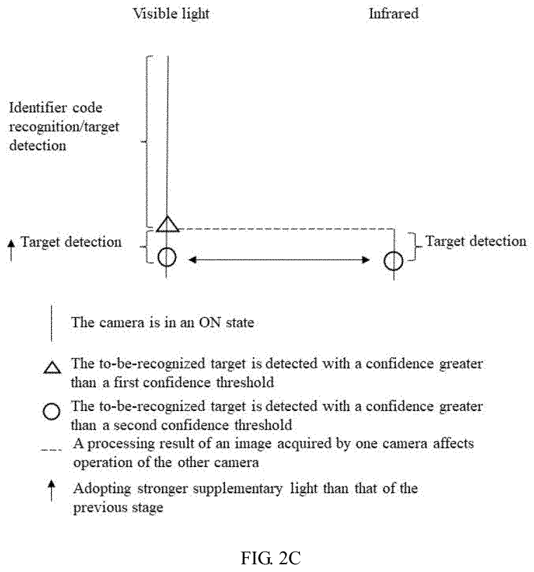

According to some embodiments, the electronic device further includes a distance sensor; and the method 100 includes step 1021, step 104, step 1011 and step 1031. FIG. 2A and FIG. 2B show a timing of image capture, identifier code recognition, and target detection performed by the visible light camera and the infrared camera according to at least one embodiment of the present disclosure.

Step 1021: acquiring, by the visible light camera, and in response to the distance sensor detecting the to-be-recognized target, a second image of the to-be-recognized target, performing identifier code recognition on the second image, and performing target detection on the second image.

In this embodiment, the visible light camera turn-on condition is that: the distance sensor detects the to-be-recognized target. The distance sensor may be an infrared sensor, an ultrasonic distance sensor, etc. It may be understood that, the distance sensor detects the to-be-recognized target may be that the distance sensor detects existence of the to-be-recognized target.

It may be understood that, the sequence of identifier code recognition and target detection on the second image may not be limited. For example, identifier code recognition may be performed firstly, and when the identifier code cannot be recognized, target detection is performed; or target detection may be performed firstly, and when the to-be-recognized target cannot be detected, identifier code recognition is performed; or identifier code recognition and target detection may be performed simultaneously, for example, one detection network is used to determine whether the to-be-recognized target in the second image is an identifier code or a target.

In one example, if the identifier code is not recognized or the to-be-recognized target is not detected, identifier code recognition and target detection both are performed on each second image. If the identifier code is not recognized and the target is not detected in the second image, identifier code recognition and/or target detection is continued performed on a next second image.

In one example, target detection is performed on each second image in which the identifier code cannot be recognized; in another example, one image is selected from N second images in which the identifier code cannot be recognized for target detection, which, thus, can reduce the number of calls of a target detection algorithm, to save computing power.

In one example, for the same second image, both identifier code recognition and target detection can be performed; in another example, for the same second image, only identifier code recognition or target detection can be performed, and a plurality of consecutive second images can alternately perform identifier code recognition and target detection. For example, for the 1st, 3rd, 5th and 7th second images, identifier code recognition are performed, and for the 2nd, 4th, 6th and 8th images, target detection are performed. For example, for the 1st, 2nd, 4th, 5th, 7th, 8th second images, identifier code recognition are performed, and for the 3rd, 6th second images, target detection are performed.

It should be noted that, the at least one second image may include a second image captured under a certain visible light supplementation condition. Visible light supplementary light is more dazzling and has a certain power consumption. Usually, it is necessary to shorten the turn-on time and reduce the brightness. For example, in the case where no identifier code is recognized during identifier code recognition and no target is detected during target detection with respect to several second images, a second image may be captured again for identifier code recognition and target detection in the case where a visible light flash is turned on, so that the identifier code printed on the paper may be prevented from being difficult to be recognized due to lack of supplementary light, and in addition, the hand may be prevented from being difficult to be recognized due to lack of supplementary light. For another example, when a hand is detected in the second image, a second image may be captured again under a condition that the flash is turned on, so as to improve quality of the image used for identity recognition.

Step 104: determining, in response to the identifier code being recognized, and according to the identifier code recognition result, an identity recognition result of the to-be-recognized object, and turning off the camera in an ON state.

It may be understood that, if in step 1021, the second image is subjected to identifier code recognition firstly, and then target detection, and the identifier code recognition result is that the identifier code is recognized, then target detection in step 1021 may not be executed, and the identity recognition result of the to-be-recognized object is directly determined according to the identifier code recognition result in step 104.

Step 1011: acquiring, by the infrared camera, and in response to the target being detected in the second image, a first image of the to-be-recognized target, and performing target detection on the first image, the target being a finger and/or a palm.

In one example, target detection on the second image, that is, the visible light image, may be performed through a neural network model. The neural network model for target detection on the visible light image may be different from the neural network model for target detection on the infrared image.

In this embodiment, the visible light image of the to-be-recognized target is used to determine whether the to-be-recognized target is the hand or the identifier code, and only when it is determined that the to-be-recognized target is the hand, the infrared camera is turned on to capture the infrared image of the hand.

It should be understood that, it is basically determined that the to-be-recognized target is the hand when acquiring the first image, and infrared flash may be turned on to obtain a first image with better quality.

Step 1031: performing, in response to the to-be-recognized target being detected from the first image, identity recognition based on the third image and a fourth image, the fourth image being at least one image among the second images in which the to-be-recognized target is detected.

The fourth image may be determined from the second image in which the to-be-recognized target is detected after the to-be-recognized target is detected in step 1021. Similar to the third image, the second image in which the to-be-recognized target is detected may be directly used as the fourth image. Quality detection may also be performed on the second image in which the to-be-recognized target is detected, and the second image sufficiently qualified is used as the fourth image. The fourth image may be one or more images.

In one example, after the to-be-recognized target is detected from the second image, a second image may be acquired under a stronger visible light supplementation condition, and the fourth image may be determined from the second image acquired under the stronger visible light supplementation condition.

In one example, after the fourth image is determined, an OFF instruction is sent to the camera, which, thence, no longer continues acquiring images, and the captured fourth image may be used for subsequent identity recognition. In another example, after the fourth image is determined, the camera is still kept on, and after the identity recognition end condition is met, the camera is turned off to stop image capture, so that in the case where no candidate object matching the to-be-recognized object is recognized based on one fourth image, the camera may capture an image again.

In some embodiments, a capture time interval between the third image and the fourth image is required to be within a preset range, such that it may be ensure that there is less hand movement in such a short time interval, so that the third image and the fourth image may be used to calibrate each other (e.g., to correct detected key points in the visible light image with the key points detected in the infrared image, etc.). In this case, the fourth image needs to be selected according to capture time of the third image, or the third image needs to be selected according to capture time of the fourth image. In other embodiments, the third image and the fourth image do not need to calibrate each other, and in this case, the third image and the fourth image that meet the requirements may be acquired respectively without considering the capture time interval of the two.

It should be understood that, if a hand is detected in the visible light image, the infrared camera is turned on after the fourth image is determined (e.g., the fourth image is A1 captured at time t1), the infrared image is captured, a hand is detected in the infrared image, and the third image is determined from the infrared image in which the hand is detected, because the infrared camera is turned on after t1, the capture time t2 of the third image is usually later than t1 and has a certain time interval from t1, as shown in FIG. 2A. Exemplarily, the third image and the fourth image with same or similar capture time may be determined in a mode below, as shown in FIG. 2B. A first mode is: turning on the infrared camera after the hand is detected in the visible light image, capturing the infrared image, detecting the hand in the infrared image, and determining the third image (e.g., the third image is B1 captured at time t2) from the infrared image in which the hand is detected, keeping on capturing visible light images, and determining the fourth image from visible light images whose capture time is the same as or similar to t2. A second mode is: turning on the infrared camera after the hand is detected in the visible light image, determining the fourth image from the visible light images captured by the visible light camera after the infrared camera is turned on, capturing, by the infrared camera, the infrared image, detecting the hand from the infrared image whose capture time is the same as or similar to that of the fourth image, and determining the third image. That is, in the case where the capture time interval between the third image and the fourth image is required to be within a preset range, for selection of the third and fourth images, not only whether the to-be-recognized target is included, the image quality, but also the capture time should be considered. For example, one of the third image and the fourth image may be selected according to the capture time of the other. In this case, even if the camera is turned off after the image for identity recognition is captured, the infrared camera and the visible light camera may be turned off after the third image and the fourth image are determined, so as to avoid the case where one of the third image and the fourth image is determined, but the other that meets the time interval requirements cannot be determined.

When the hand is detected in the first image and the second image, the infrared image (the third image) and the visible light image (the fourth image) containing the hand are used for identity recognition by using biometric features rich in palm prints and palm veins, so that accuracy of identity recognition may be improved.

In this embodiment, the visible light camera is turned on firstly, the visible light image is used to determine whether the to-be-recognized target is a hand or an identifier code, the infrared image is captured after determining that the to-be-recognized target is a hand, and target detection is performed on the infrared image. In this way, the turn-on time of the infrared camera is reduced, and target detection is only performed on the images captured by one camera at the same time, which can save computing power and reduce power consumption. Meanwhile, the biometric features rich in palm prints and palm veins may be used for identity recognition, which, thus, can improve accuracy of identity recognition.

According to some embodiments, the method 100 includes step 1021a, step 104, step 105, step 1011a and step 1031a, and FIG. 2C shows a timing of image capture, identifier code recognition, and target detection performed by the visible light camera and the infrared camera according to the embodiments of the present disclosure.

Step 1021a: acquiring, by the visible light camera, in response to the distance sensor detecting the to-be-recognized target, and under a first visible light supplementation condition, a second image of the to-be-recognized target, performing identifier code recognition on the second image captured under the first visible light supplementation condition, and performing target detection on the second image captured under the first visible light supplementation condition.

Step 104: determining, in response to the identifier code being recognized, and according to the identifier code recognition result, an identity recognition result of the to-be-recognized object, and turning off the camera in an ON state.

Step 105: capturing, by the visible light camera, in response to the to-be-recognized target being detected from the second image captured under the first visible light supplementation condition with a confidence greater than a first confidence threshold, the second image under a second visible light supplementation condition, and performing target detection on the second image captured under the second visible light supplementation condition.

Step 1011a: acquiring, by the infrared camera, in response to the to-be-recognized target being detected from the second image captured under the first visible light supplementation condition with a confidence greater than the first confidence threshold, the first image of the to-be-recognized target, and performing target detection on the first image.

Step 1031a: performing, in response to the to-be-recognized target being detected from the first image with a confidence greater than the second confidence threshold, identity recognition based on the third image and the fourth image, the fourth image being at least one image among the second images in which the to-be-recognized target is detected with a confidence greater than the second confidence threshold, and captured under the second visible light supplementation condition, and the second confidence threshold being higher than the first confidence threshold.

In one example, the target detection is performed through a neural network model, and the target detection result is a confidence of the image containing the to-be-recognized target, and a confidence threshold may be set; if the confidence is greater than the confidence threshold, it is considered that the to-be-recognized target is detected, otherwise, it is considered that no to-be-recognized target is detected. A plurality of different confidence thresholds may also be set, for example, reaching the first confidence threshold indicates that there is a certain probability that a hand exists in the first image, reaching the second confidence threshold indicates that there is a greater probability that a hand exists in the first image, and the second confidence threshold is greater than the first confidence threshold.

In a possible procedure, the to-be-detected target gradually approaches to the camera, the distance sensor detects existence of the to-be-detected target, the visible light camera is turned on, and the visible light camera captures the visible light image of the to-be-detected target under the first visible light supplementation condition and performs identifier code recognition and target detection; but because the to-be-detected target is relatively small in the picture, the confidence of the to-be-recognized target being detected in the second image is less than the first confidence threshold; as the to-be-detected target continues to approach the camera, the confidence of the to-be-recognized target being detected in the second image increases, for example, increases to be greater than or equal to the first confidence threshold (e.g., the first confidence threshold is 40 points), at this time, the first image detects a “hand-like” target, and the infrared camera is turned on to start capturing an infrared image; and under the second visible light supplementation condition, a visible light image is captured by the visible light camera.

The first visible light supplementation condition may be that the visible light flash is not turned on, and the second visible light supplementation condition is that visible light flash is turned on. Or, the first visible light supplementation condition is that the visible light flash is turned on with lower brightness, and the second visible light supplementation condition is that the visible light flash is turned on with higher brightness. Because the visible light flash is relatively dazzling and has a certain power consumption, the visible light flash is hoped to be turned on with a shortest possible duration and lowest possible brightness. If the to-be-recognized target is an identifier code, the identifier code is usually displayed on a medium with a backlight such as a mobile phone, in this case, the identifier code may be recognized without light supplementation; if the to-be-recognized target is the hand, some visible light supplementation is usually needed so as to acquire a visible light image with better quality that may be used for identity recognition; in this case, a visible light image may be captured under the second visible light supplementation condition after a “hand-like” target is detected in the visible light image, to shorten the turn-on time of the visible light flash with higher brightness. It should be understood that, in step 1011a, the infrared light flash may be turned on when acquiring the first image.

To save computing power, target detection performed on the second image captured under the second visible light supplementation condition in step 105 and target detection performed on the first image in step 1011a may be executed asynchronously. For example, firstly target detection is performed on the second image captured under the second visible light supplementation condition, the fourth image is determined from the second image in which the to-be-recognized target is detected with a confidence greater than the second confidence threshold, then target detection is performed on the first image whose capture time is the same as or similar to that of the fourth image, and the third image is determined from the first image in which the to-be-recognized target is detected with a confidence greater than the second confidence threshold. Or, target detection is performed on the first image, the third image is determined from the first image in which the to-be-recognized target is detected with a confidence greater than the second confidence threshold, then target detection is performed on the second image whose capture time is the same as or similar to that of the third image, and the fourth image is determined from the second image in which the to-be-recognized target is detected with a confidence greater than the second confidence threshold. Of course, if the computing power consumption of target detection algorithm is not considered, target detection may also be performed simultaneously on the second image and the first image captured under the second visible light supplementation condition.

In this embodiment, firstly the visible light image is captured under the first visible light supplementation condition, and after there is a certain probability to detect the to-be-recognized target in the visible light image, the visible light image is captured under the second visible light supplementation condition with a greater light supplementation intensity than the first visible light supplementation condition and then target detection is performed, so that the visible light flash may be turned on with a shortest possible duration and lowest possible brightness, which can take into account high image quality, low power consumption and good user experience.

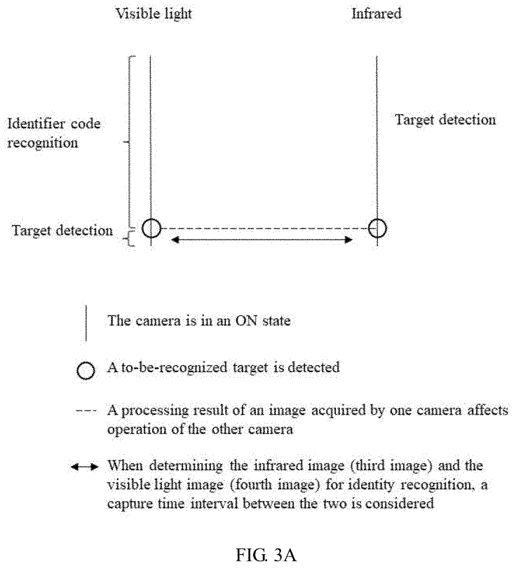

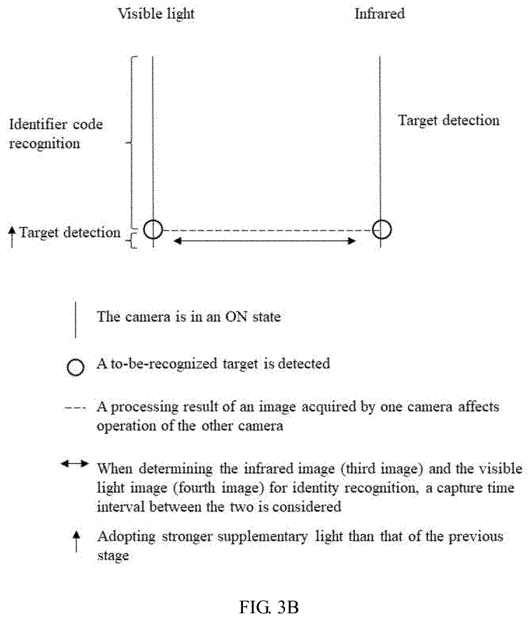

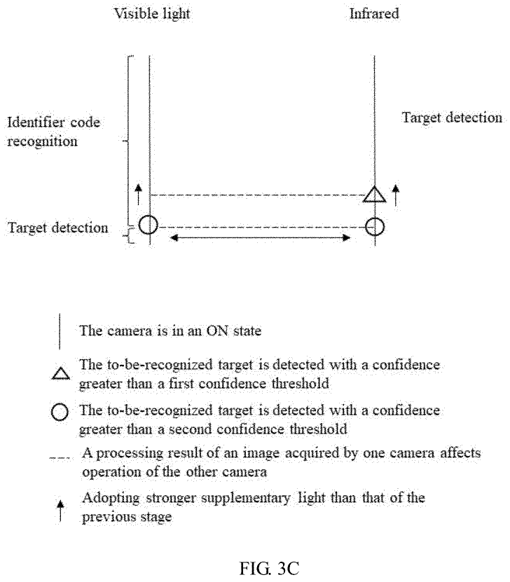

According to some embodiments, the electronic device further includes a distance sensor, and the method 100 includes step 1012, step 1022, step 1032 and step 104. FIG. 3A shows a timing of image capture, identifier code recognition, and target detection performed by the visible light camera and the infrared camera according to the embodiment of the present disclosure.

Step 1012: acquiring, by the infrared camera, and in response to the distance sensor detecting a to-be-recognized target, a first image of the to-be-recognized target, and performing target detection on the first image, the target being a finger and/or a palm.

Step 1022: acquiring, by the visible light camera, in response to the distance sensor detecting the to-be-recognized target, a second image of the to-be-recognized target, and performing identifier code recognition on the second image.

In this embodiment, the turn-on condition of both the infrared camera and the visible light camera is that: the distance sensor detects existence of the to-be-recognized target.

Step 1032: no longer performing, in response to the to-be-recognized target being detected from the first image, identifier code recognition on the second image, and performing target detection on the second image, the target being a finger and/or palm; performing, in response to the to-be-recognized target being detected from the second image, identity recognition based on a third image and a fourth image, the third image being at least one image from the first images in which the to-be-recognized target is detected, and the fourth image being at least one image from the second images in which the to-be-recognized target is detected.

The foregoing embodiments may be referred to for descriptions of the third image and the fourth image.

It should be understood that, in this embodiment, after the hand is detected in the infrared image and the third image (e.g., the third image is B1 captured at time t2) is determined, the fourth image may be determined from the visible light image whose capture time is the same as or similar to that of the third image (because the visible light camera is also in an ON state at t2, and the visible light image captured at a moment the same as or similar to t2 has been captured), in this way, the third image and the fourth image with the same or similar capture time may be determined.

In a specific embodiment, in response to the to-be-recognized target being detected from the first image, the third image is determined from the first image in which the to-be-recognized target is detected; identifier code recognition is no longer performed on the second image; target detection is performed on the second image among the second images whose capture time interval to the third image is within a preset range; and if the to-be-recognized target is detected from the second image (and the image is qualified), the second image is determined as the fourth image. If no to-be-recognized target is detected from the second image or the to-be-recognized target is unqualified though detected, target detection is performed on the other first images to determine a third image, and target detection is performed on the second image among the second images whose capture time interval to the third image is within a preset range, to determine a fourth image. Here, the other first images may be those captured again, or may also be those previously captured and cached.

Step 104: determining, in response to the identifier code being recognized, and according to the identifier code recognition result, an identity recognition result of the to-be-recognized object, and turning off the camera in an ON state.

In this embodiment, the turn-on condition of both the infrared camera and the visible light camera is that: the distance sensor detects existence of the to-be-recognized target; identifier code recognition is performed on the visible light image, and meanwhile, target detection is performed on the infrared image; in the case where the to-be-recognized target can be determined as a hand through the infrared image, identifier code recognition is no longer performed on the visible light image, and instead, target detection is performed on the visible light image. In this way, whether the to-be-recognized target is a hand or an identifier code can be determined as early as possible, thereby improving the recognition speed; in addition, target detection is performed only on images captured by one camera at the same time, which can save computing power and reduce power consumption; meanwhile, it is also easier to determine an infrared image and a visible light image having same or similar capture time for identity recognition.

According to some embodiments, step 1022 of the method 100 includes step 1022a: capturing, by the visible light camera, and in response to the visible light camera turn-on condition being met, the second image under the first visible light supplementation condition. Step 1032 includes step 1032a: capturing, by the visible light camera, and in response to the to-be-recognized target being detected from the first image, the second image under the second visible light supplementation condition; no longer performing identifier code recognition on the second image captured under the second visible light supplementation condition; and performing target detection on the second image captured under the second visible light supplementation condition; and the light supplementation intensity of the second visible light supplementation condition being stronger than the light supplementation intensity of the first visible light supplementation condition. In response to the to-be-recognized target being detected from the second image captured under the second visible light supplementation condition, identity recognition is performed based on the third image and the fourth image, the third image is at least one image among the first images in which the to-be-recognized target is detected, and the four image is at least one image among the second images captured under the second visible light supplementation condition in which the to-be-recognized target is detected. FIG. 3B shows a timing of image capture, identifier code recognition, and target detection performed by the visible light camera and the infrared camera according to the embodiment of the present disclosure.

The first visible light supplementation condition may be that the visible light flash is not turned on, and the second visible light supplementation condition may be that the visible light flash is turned on. Or, the first visible light supplementation condition is that the visible light flash is turned on with lower brightness, and the second visible light supplementation condition is that the visible light flash is turned on with higher brightness. Because the visible light flash is relatively dazzling and has a certain power consumption, the visible light flash is hoped to be turned on with a shortest possible duration and lowest possible brightness. If the to-be-recognized target is an identifier code, the identifier code is usually displayed on a medium with a backlight such as a mobile phone, in this case, the identifier code may be recognized without light supplementation; if the to-be-recognized target is the hand, some visible light supplementation is usually needed so as to acquire a visible light image with better quality that may be used for identity recognition; in this case, a visible light image may be captured under the second visible light supplementation condition after the hand is detected in the infrared image, to shorten the turn-on time of the visible light flash with higher brightness.

In this embodiment, firstly the visible light image is captured under the first visible light supplementation condition and identifier code recognition is performed, and after the to-be-recognized target is detected in the infrared image, the visible light image is captured under the second visible light supplementation condition with a greater light supplementation intensity than the first visible light supplementation condition and then target detection is performed, so that the visible light flash may be in turned on with a shortest possible duration and lowest possible brightness, which can take into account high recognition speed, high image quality, low power consumption and good user experience.

According to some embodiments, the method 100 includes step 1012, step 1022a, step 1032a and step 104. FIG. 3C shows a timing of image capture, identifier code recognition, and target detection performed by the visible light camera and the infrared camera according to the embodiment of the present disclosure. Step 1032a includes step 1032a1: capturing, by the visible light camera, and in response to the to-be-recognized target being detected from the first image with a confidence greater than the first confidence threshold, the second image under the second visible light supplementation condition, and performing identifier code recognition on the second image captured under the second visible light supplementation condition; no longer performing, in response to the to-be-recognized target being detected from the first image with a confidence greater than the second confidence threshold, identifier code recognition on the second image captured under the second visible light supplementation condition, and performing target detection on the second image captured under the second visible light supplementation condition; the light supplementation intensity of the second visible light supplementation condition being greater than the light supplementation intensity of the first visible light supplementation condition, and the second confidence threshold being greater than the first confidence threshold. In response to the to-be-recognized target being detected from the second image captured under the second visible light supplementation condition, identity recognition is performed based on the third image and the fourth image, the third image is at least one image in the first images among which the to-be-recognized target is detected, and the fourth image is at least one image among the second images in which the to-be-recognized target is detected with a confidence greater than the second confidence threshold.

In one example, the target detection is performed through a neural network model, and the target detection result is a confidence of the image containing the to-be-recognized target; if the confidence is greater than the confidence threshold, it is considered that the to-be-recognized target is detected; otherwise, it is considered that the to-be-recognized target is not detected. A plurality of different confidence thresholds may also be set, for example, reaching the first confidence threshold indicates that there is a certain probability that a hand exists in the first image, reaching the second confidence threshold indicates that there is a greater probability that a hand exists in the first image, and the second confidence threshold is greater than the first confidence threshold.

In a possible procedure, the to-be-detected target gradually approaches to the camera, the distance sensor detects existence of the to-be-detected target, the visible light camera and the infrared camera are turned on, and the visible light camera captures the visible light image of the to-be-detected target under the first visible light supplementation condition and performs identifier code recognition, the infrared camera captures the infrared image of the to-be-detected target and performs target detection; but because the to-be-detected target is relatively small in the picture, the confidence of the to-be-recognized target being detected in the first image is less than the first confidence threshold; as the to-be-detected target continues to approach the camera, the confidence of the to-be-recognized target being detected in the first image increases, for example, increases to be greater than or equal to the first confidence threshold (e.g., the first confidence threshold is 40 points); at this time, the first image detects a “hand-like” target, and under the second visible light supplementation condition, the visible light camera continuously captures visible light images and performs identifier code recognition on the visible light images captured under the second visible light supplementation condition. As the to-be-recognized target continues to approach the camera, the confidence of the to-be-recognized target being detected in the first image continues to increase, for example, increases to be greater than or equal to the second confidence threshold (e.g., the second confidence threshold is 90 points); at this time, the first image detects a target “basically determined to be a hand”, thence, identifier code recognition is no longer performed on the second image captured under the second visible light supplementation condition, and target detection is performed on the second image captured under the second visible light supplementation condition.

That is, in this embodiment, the time point at which the light supplementation intensity of the visible light camera is increased is separated from the time point when processing on the first image is changed from identifier code recognition to target detection; so the light supplementation intensity is increased first, which is performed in response to the “hand-like” target being detected in the first image, and then identifier code recognition is changed to target detection, which is performed in response to the “target that is basically a hand” being detected in the first image. In this way, on a first aspect, target detection may be performed only on images captured by one camera at the same time; on a second aspect, the fourth image with better quality whose shooting time is close to the shooting time of the third image may be obtained as early as possible; and on a third aspect, in the case where the to-be-recognized target is an identifier code printed on paper, the visible light image containing the to-be-recognized object may have sufficient light supplementation so as to be recognized.

It should be understood that, the infrared light supplementation condition may also be adjusted according to the target detection result of the infrared image. For example, firstly the infrared image is captured under the first infrared light supplementation condition and target detection is performed; after the to-be-recognized target is detected in the infrared image with a confidence greater than the first confidence threshold, the infrared image is captured under the second infrared light supplementation condition with a greater light supplementation intensity than the first infrared light supplementation condition and then target detection is performed, so that a third image with better quality may be acquired as early as possible.

According to some embodiments, the performing identity recognition based on the third image and the fourth image in step 1031, step 1031a, step 1032, step 1032a or step 1032a1 includes the following steps.

Step 1033: performing feature extraction on the third image to obtain an infrared feature of the to-be-recognized object.

Step 1034: performing feature extraction on the fourth image to obtain a visible light feature of the to-be-recognized object.

Step 1035: performing identity recognition according to the infrared feature of the to-be-recognized object, the visible light feature of the to-be-recognized object, an infrared feature of the candidate object, and a visible light feature of the candidate object.

The infrared feature includes at least one selected from a group consisting of: a palm vein global feature, a palm vein minutiae feature, and a finger vein global feature, and the visible light feature includes a palm print global feature.

It should be understood that, before feature extraction is performed on the third image and the fourth image, the third image and the fourth image may be preprocessed. The preprocessing is, for example, determining a region of interest according to key points (the key points may be acquired during target detection, and the target detection result includes not only the confidence, but also positions of the key points). Performing feature extraction on the third image and the fourth image may be performing feature extraction on regions of interest corresponding to the third image and the fourth image. Specifically, in the case where the to-be-extracted feature is the palm vein global feature and the palm print global feature, the region of interest is a palm region. Thereafter, feature extraction may be performed on the region of interest to obtain the corresponding palm vein global feature and palm print global feature. In the case where the to-be-extracted feature is the finger vein global feature, the region of interest is a finger region. Thereafter, feature extraction is performed on the segmented finger region, and finger vein features of respective fingers are spliced into a finger vein global feature. In the case where the infrared feature includes the palm vein minutiae feature, the region of interest is a palm region; a palm vein line is extracted from the region of interest, the minutiae is recognized, and then position, direction, and description information of respective minutia are determined as the palm vein minutiae feature.

It should be understood that, when the candidate object is registered, the infrared image and the visible light image of the hand of the candidate object are captured, and the corresponding infrared features and visible light features are extracted.

In this embodiment, abundant finger and palm print features, and finger and palm vein features with different degrees of discrimination and computing power consumption are used for identity recognition, which can take into account both accuracy and speed of identity recognition.

According to some embodiments, step 1035 specifically includes the following steps.

Step 1035a: calculating a first-level similarity between a first-level feature of the to-be-recognized object and a first-level feature of the current candidate object, and taking the current candidate object whose first-level similarity meets a first matching condition as a candidate object matching the to-be-recognized object, taking the current candidate object whose first-level similarity meets a second matching condition as a candidate object not matching the to-be-recognized object, and the current candidate object being one of the plurality of candidate objects. The first matching condition is, for example, greater than first similarity threshold; the second matching condition is, for example, smaller than the second similarity threshold, in one example, the first similarity threshold and the second similarity threshold are 99.9% and 40%, respectively.

It should be understood that a first-level feature may include a plurality of first-level sub-features. For example, the first-level sub-feature A includes the global features of palmprint, the first-level sub-feature B includes the fusion features of palmprint global features and palmprint global features, and the first-level sub-feature C includes the fusion features of palmprint global features, palmprint global features and finger vein global features. First, the first-level sub-feature A can be used for quick pass/quick filter (when meets the first matching condition A, quick pass, when meets the second matching condition A, quick filter, otherwise, go to the next round). For those candidates that have not been passed/filtered by the first-level sub-feature A, the first-level sub-feature B can be used for quick pass/quick filter (when meets the first matching condition B, quick pass, when meets the second matching condition B, quick filter, otherwise, go to the next round). For those candidates that have not been passed/filtered by the first-level sub-feature B, the first-level sub-feature C is used for quick pass/quick filter (when meets the first matching condition C, quick pass, when meets the second matching condition C, quick filter). The first matching condition A, B and C can be the same or different, the second matching condition A, B and C can be the same or different.

Step 1035b: determining, in response to the current candidate object being the candidate object matching the to-be-recognized object, that the identity recognition result of the to-be-recognized object is the current candidate object, where step 1035 ends.

Step 1035c: taking a candidate object among the plurality of candidate objects that has not been taken as a current candidate object as the current candidate object.

Step 1035a, step 1035b and step 1035c are executed until all candidate objects among the plurality of candidate objects have been taken as the current candidate object.

That is, step 1035a, step 1035b (whether to execute step 1035b depends on whether the execution condition of step 1035b is met), and step 1035c are executed cyclically until all the candidate objects among the plurality of candidate objects have been taken as the current candidate object.

The first-level feature includes at least one selected from a group consisting of: the palm vein global feature, the finger vein global feature, the palm print global feature, and a fusion feature, and the fusion feature is obtained by fusing at least two selected from a group consisting of: the palm vein global feature, the finger vein global feature, and the palm print global feature. For example, the fusion feature can be obtained by fusing the palm vein global feature and the palm print global feature, and the fusion feature can also be obtained by fusing the palm vein global feature, the palm print global feature and the finger vein global feature. Fusing the feature can be concatenation of features.

Different features have different degrees of discrimination/computing power consumption. For example, extracting the palm print global feature consumes less computing power. However, the degree of discrimination of the palm print global feature of palm shape is usually low. The finger vein global feature needs to be obtained by finger segmentation and feature extraction, which consumes greater computing power.

The degree of discrimination of a certain feature or a combination of several certain features is related a similarity threshold corresponding thereto, and by selecting an appropriate similarity threshold, the feature or the feature combination may reach a maximum possible degree of discrimination.

The degree of discrimination of a certain feature or a combination of several certain features is further related to the candidate database. With respect to the candidate database containing different candidate objects, the same feature may also have different degrees of discrimination. For example, the case may be that, the palm vein global feature has a better degree of discrimination with respect to manual workers, while the palm print global feature has a better degree of discrimination with respect to children.

In the case where the number of candidate objects in the candidate database is large (e.g., 100w), it is hoped to perform first screening with some features having less computing power consumption and an acceptable degree of discrimination during feature extraction and feature comparison, to quickly filter out candidate objects that are impossible to match (e.g., filter out 97w), and obtain a smaller number of candidate objects that are possible to match, and then perform second screening on the candidate objects, which are possible to match, with some features having more computing power consumption and a higher degree of discrimination during feature extraction and feature comparison. It should be understood that, in the case where the degree of discrimination of the feature used in the first screening is sufficient, the identity recognition result may also be obtained only through the first screening without performing the second screening. The features used in the first screening are referred to as the first-level feature. Usually, the feature with a greater ratio of degree of discrimination to computing power consumption (i.e., the feature having a higher degree of discrimination and lower computing power consumption) is taken as the first-level feature preferably.

It should be understood that, the first-level feature may be a single feature or a combination of a plurality of features. In the case where the first-level feature is the combination of the plurality of features, the first-level similarity may be a combination of similarities of the plurality of features, or may also be a single similarity obtained according to similarities of the plurality of features. For example, the first-level feature is a combination of the palm vein global feature and the palm print global feature, and the first-level similarity may be a combination of the palm print global feature similarity 60 and the palm vein global feature similarity 90 {60, 90}; correspondingly, the first matching condition and the second matching condition may include a combination of similarity thresholds, for example, the first matching condition is that the first similarity is greater than {99, 99}, and the second matching condition is that the first similarity is less than {60, 60}. For another example, the first-level similarity may also be a similarity 75 obtained by a weighted average of the palm print global feature similarity and the palm vein global feature similarity; correspondingly, the first and second matching conditions may include a single similarity threshold, for example, the first matching condition is that the first similarity is greater than 99, and the second matching condition is that the first similarity is less than 50. It should be understood that, in the case where the first-level feature contains only one feature, the similarity threshold corresponding to the first matching condition is usually higher than that in the case where the first-level feature is a feature combination, for example, in the case where the first-level feature is a combination of the palm vein global feature and the palm print global feature, the first matching condition is that the first similarity is greater than {99, 99}, and in the case where the first-level feature is the palm print global feature, the first matching condition is that the first similarity is greater than 99.9.

In step 1035b, in the case where the similarity between a candidate object and the to-be-recognized object is extremely high, the candidate object is determined as an object matching the to-be-recognized object and the identity recognition flow is ended, so that similarities between other candidate objects and the to-be-recognized object are no longer calculated, which can increase identity recognition speed.

If no candidate object matching the to-be-recognized object is determined after all the candidate objects in the candidate database have been taken as the current candidate object, selection and identity recognition on the third image and the fourth image may be performed again. When the number of times of identity recognition reaches the preset number of times, or time consumption for identity recognition reaches a preset duration, the returned identity recognition result is that identity recognition fails.

According to some embodiments, step 1035 specifically includes the following steps.

Step 1035a1: calculating a first-level similarity between a first-level feature of the to-be-recognized object and a first-level feature of the current candidate object, taking the current candidate object whose first-level similarity meets a first matching condition as the candidate object matching the to-be-recognized object, taking the current candidate object whose first-level similarity meets a second matching condition as a candidate object not matching the to-be-recognized object, and taking the current candidate object whose first-level similarity meets a third matching condition as an alternative candidate object; and the current candidate object being one of the plurality of candidate objects. The third matching condition may be that neither the first matching condition nor the second matching condition is meets. For example, the first matching condition is the first-level similarity is greater than 99.9%, the second matching condition is the first-level similarity is smaller than 40%, the third matching condition is that the first-level similarity is not smaller than 40% nor greater than 99.9%. Similarly, the first-level feature can include a plurality of first-level sub-features, and the detailed description is given in the previous text, so it will not be repeated here.

Step 1035b: determining, in response to the current candidate object being the candidate object matching the to-be-recognized object, that the identity recognition result of the to-be-recognized object is the current candidate object, where step 1035 ends.

Step 1035c: taking a candidate object among the plurality of candidate objects that has not been taken as the current candidate object as the current candidate object.

Step 1035a1, step 1035b, and step 1035c are executed cyclically until all the candidate objects among the plurality of candidate objects have been taken as the current candidate object.

That is, step 1035a1, step 1035b (whether to execute step 1035b depends on whether an execution condition of step 1035b is met), and step 1035c are executed cyclically until all the candidate objects among the plurality of candidate objects have been taken as the current candidate object.

Step 1035e: calculating, in response to all the candidate objects among the plurality of candidate objects having been taken as the current candidate object and no candidate object matching the to-be-recognized object being determined, a secondary similarity between a secondary feature of the to-be-recognized object and a secondary feature of at least some of the alternative candidate objects.

In the case where the number of alternative candidate objects is too large, top k alternative candidate objects with highest first-level similarities to the to-be-recognized object may be selected to calculate the secondary similarity.

Step 1035f: determining, according to the secondary similarity, whether the alternative candidate object is a candidate object matching the to-be-recognized object.

The secondary feature includes at least one selected from at least one a group consisting of: the palm vein global feature, the finger vein global feature, the palm print global feature, the palm vein minutiae feature, and the fusion feature that are different from the first-level feature. For example, in the case where the first-level feature is a global feature, the secondary feature may include a local feature such as the palm vein minutiae feature.

After all the candidate objects among the plurality of candidate objects have been taken as current candidate objects and no candidate object matching the to-be-recognized object is determined, the secondary similarity between the secondary feature of the to-be-recognized object and at least some of the alternative candidate objects may be calculated in step 1035e, so in step 1035f, it is determined whether there is a candidate object matching the to-be-recognized object among the alternative candidate objects according to the secondary similarity alone, or a combination of the first-level similarity and the secondary similarity. For example, an alternative candidate object whose secondary similarity is greater than the threshold and is the greatest is determined as the identity recognition result, or the alternative candidate object whose similarity obtained by the weighted average of the first-level similarity and the secondary similarity is greater than the threshold and is the greatest is determined as the identity recognition result.

If no candidate object matching the to-be-recognized object is determined among the alternative candidate objects, selection and identity recognition on the third image and the fourth image may be performed again. When the number of times of identity recognition reaches the preset number of times, or time consumption for identity recognition reaches the preset duration, the returned identity recognition result is that identity recognition fails.

According to some embodiments, the secondary feature includes the palm vein minutiae feature, and the palm vein minutiae feature includes a plurality of target intersections between a plurality of feature lines representing palm vein distribution of the to-be-recognized object, and related parameters of each of the plurality of target intersections; the related parameters include at least one selected from a group consisting of: a position of a target intersection in a to-be-recognized feature image, a direction of a feature line, where the target intersection is located, at the target intersection, a spacing between the target intersection and an adjacent target intersection, an angle of a connecting line between the target intersection and the adjacent target intersection, a position of the adjacent target intersection of the target intersection in the to-be-recognized feature image, and a direction of a feature line, where the adjacent target intersection is located, at the adjacent target intersection. The secondary feature includes the palm vein minutiae feature, and the palm vein minutiae feature includes a plurality of target intersections between a plurality of feature lines representing palm vein distribution of the to-be-recognized object and related parameters of each of the plurality of target intersections; the related parameters include at least one selected from a group consisting of: a position of a target intersection in a to-be-recognized feature image, a direction of a feature line, where the target intersection is located, at the target intersection, a spacing between the target intersection and an adjacent target intersection, an angle of a connecting line between the target intersection and the adjacent target intersection, a position of the adjacent target intersection of the target intersection in the to-be-recognized feature image, and a direction of a feature line, where the adjacent target intersection is located, at the adjacent target intersection.

The to-be-recognized feature image is obtained by processing the third image, and the to-be-recognized feature image includes a plurality of feature lines capable of representing palm vein distribution of the to-be-recognized object; correspondingly, the alternative candidate object corresponds to an alternative feature image; the alternative feature image is obtained by processing the infrared image of the alternative candidate object, and the alternative feature image includes a plurality of feature lines capable of representing palm vein distribution of the alternative candidate object. The to-be-recognized feature image and the alternative feature image will be described in detail below.

In step 1035e, the similarity between the secondary feature of the to-be-recognized object and the secondary feature of each alternative candidate object among at least some of the alternative candidate objects may be calculated, and the calculating the similarity between the secondary feature of the to-be-recognized object and a secondary feature of one alternative candidate object may include the following steps.

Step A: selecting at least one of a plurality of target intersections corresponding to the to-be-recognized feature image as an initial point.

Specifically, index features of the plurality of target intersections may be obtained respectively, and then the initial point is selected according to the above-described index features. The index feature of one target intersection is determined according to at least one related parameter of the related parameters of the target intersection.

Step B: determining a maximum matching connectivity graph based on the initial point, and each target intersection included in the maximum matching connectivity graph has a matching intersection in the alternative feature image, in which the matching intersection is a point among the alternative intersections matching the target intersection, the alternative intersections are intersections between a plurality of feature lines that represents palm vein distribution of the alternative candidate object, and whether the target intersection matches the alternative intersections is determined according to the related parameters of the target intersection and the alternative intersections.

The target intersections included in the maximum matching connectivity graph are in communication with each other. An adjacent intersection of a target intersection in the maximum matching connectivity graph either exists in the maximum matching connectivity graph, or does not exist in the maximum matching connectivity graph because there is no matching intersection in the alternative feature image. Generally speaking, with respect to a target intersection located on an edge of the maximum matching connectivity graph, an adjacent intersection thereof does not have a matching intersection in the alternative feature image.

It should be understood that, the maximum matching connectivity graph may be a graph structure rather than an image.

Step C: determining the second similarity between the to-be-recognized object and the alternative candidate object according to a matching score corresponding to at least one maximum matching connectivity graph.

The matching score corresponding to the maximum matching connectivity graph may be determined by the number of target intersections contains thereby and a matching score between reach target intersection and an alternative intersection, and the matching score between the target intersection and the alternative intersection may be determined by related parameters of the target intersection and the alternative intersection.

According to some embodiments, step B includes the following steps.

Step B1: judging, based on a related parameter of the initial point, whether there is a candidate intersection matching the initial point in the alternative feature image.

Step B2: determining, in response to there being a matching candidate intersection, at least one adjacent target intersection adjacent to the initial point among the plurality of target intersections.

Step B3: judging, based on a related parameter of each adjacent target intersection, whether a candidate intersection corresponding to the adjacent target intersection in the alternative feature image is a matching intersection of the adjacent target intersection.

Step B4: taking, in response to it being determined that the candidate intersection corresponding to the adjacent target intersection in the alternative feature image is the matching intersection of the adjacent target intersection, the adjacent target intersection as a new initial point.

Steps B1 to B4 are repeated until it is determined that there is no candidate intersection matching the adjacent target intersection, so as to obtain the maximum matching connectivity graph including the target intersections corresponding to all previous matching intersections.

In this embodiment, firstly, an initial point is selected; then it is determined, one by one in an order of spreading outward from the initial point, whether there is a matching intersection for each target intersection; and then based on the target intersections corresponding to all the determined matching intersections, the maximum matching connectivity graph is obtained.

In step B1, a matching intersection corresponding to the initial point is determined as a candidate initial point among the plurality of candidate intersections of the alternative feature images of the alternative candidate object. The matching condition for determining matching may be set according to the related parameters of the initial point and the candidate initial points corresponding thereto. Taking FIG. 5 as an example, if point A is the initial point, related parameters of point A may be compared with related parameters of the plurality of candidate intersections of the alternative feature images; if it is determined that point A and a candidate intersection A′ among the plurality of candidate intersections meet an initial matching condition, then A′ is determined as the candidate initial point. The above-described initial matching condition may be, for example, that: the difference between the related parameters of points A and A′ is less than a preset value, which, for example, may be that the difference between coordinates of point A in the to-be-recognized feature image and coordinates of point A′ in the alternative feature image of the corresponding alternative candidate object is less than a certain threshold.

In step B2, at least one adjacent intersection adjacent to the above-described initial point is determined in the to-be-recognized feature image to be taken as a point for subsequent comparison. As shown in FIG. 5, points adjacent to point A may be points B, C and D.

In step B3, it is sequentially determined whether the plurality of adjacent intersections obtained in step B2 have matched matching intersections in the alternative feature image of the alternative candidate object. As shown in FIG. 5, point B′ in the alternative feature image may be determined based on the positional relationship between point B and point A in the to-be-recognized feature image and A′ in the alternative feature image, and point B′ corresponds to point B. Thereafter, point B and point B′ are compared to determine whether the two points match each other. Specifically, whether points B and B′ match each other may be determined through the related parameters of points B and B′ in their respective feature images, and whether points B and B′ match each other may be determined according to a preset matching condition. Exemplarily, if the coordinate difference between coordinates of points B and B′ in their respective feature images is less than a preset coordinate difference, it is determined that points B and B′ match each other; or if an angle difference between an extending direction of a feature line connected with point B and an extending direction of a corresponding feature line connected with point B′ is less than a preset angle, it is determined that the points B and B′ match each other. It should be understood that, there are other matching conditions for determining whether two intersections match each other through the related parameters of the two intersections, which will not be listed here one by one; in short, implementation of the present disclosure is not limited by these matching conditions. If points B and B′ do not meet the matching conditions listed above, it is determined that point B′ does not match point B, or, the intersection B′ corresponding to the adjacent target intersection B in the alternative feature image is not a matching intersection of the adjacent target intersection. Subsequently, the above-described method continues to be used to determine whether intersections corresponding point C and point D in the alternative feature image are matching intersections of point C and point D.

Thereafter, the above-described matching operation is repeated by taking the adjacent intersection as a new initial point until all matching intersections are determined, so as to obtain the maximum matching connectivity graph including all the matching intersections. If it is determined that there is a matching intersection among the above-described adjacent intersection, the adjacent intersection is taken as a new initial point to repeat the above-described matching operation. For example, in step B3, it is determined that point B in FIG. 5 has a matching intersection point B′ in the alternative candidate object, then with point B as a starting point, continue to find points E, F, etc. adjacent to point B, and then it is determined whether there is a matching intersection among these new adjacent intersections. If it is determined in step B3 that there is no matching intersection point of a certain point, then comparison of the adjacent intersections with the point as the initial point is terminated. For example, if point C does not have a matching intersection in the alternative candidate object, then comparison of adjacent points of point C (e.g., points G, H, etc.) is terminated.

By using the above-described method, it is determined, in an order of radiating and expanding outward from the initial point, whether there is a matching intersection for each target intersection; finally, matching intersections connected into a patch, that is, the maximum matching connectivity graph, may be obtained; subsequently, the matching degree between the to-be-recognized object and the alternative candidate object currently subjected to the matching operation may be determined according to the number of target intersections included in the maximum connectivity graph and/or the matching degree between respective target intersections and matching intersections corresponding thereto. The method according to this embodiment enables each target intersection to be compared with corresponding candidate intersection one by one without loss of comparison points, so the determination result is more accurate. In the case where a certain target intersection does not match, adjacent intersections adjacent thereto no longer match by default, so there is no need to compare subsequent adjacent points, thereby reducing workload of the matching operation and improving efficiency of the matching operation.

According to some embodiments, step 1033 and step 1034 include the following steps.

Step 1033a/step 1034a: performing at least part of first-level feature extraction on the third image and/or the fourth image to obtain at least part of the first-level feature of the to-be-recognized object.

It should be understood that when a first-level feature includes plurality of first-level sub-features, the plurality of sub-features may not be extracted simultaneously. If the identity recognition result is determined just by the first-level sub-feature A, there is no need to extract the first-level sub-feature B. The first-level sub-feature B is extracted only when the first-level sub-feature B is needed for identity recognition, which, thus, can further save computing power and reduce power consumption. Step 1033b/step 1034b: performing, in response to all the candidate objects among the plurality of candidate objects having been taken as the current candidate object and no candidate object matching the to-be-recognized object being determined, secondary feature extraction on the third image and/or the fourth image to obtain the secondary feature of the to-be-recognized object.

That is, the first-level feature and the secondary feature are not extracted simultaneously; if the identity recognition result is determined just by the first-level feature, there is no need to extract the secondary feature; and the secondary feature is extracted only when the secondary feature is needed for identity recognition, which, thus, can further save computing power and reduce power consumption.

In this case, the performing identity recognition based on the third image and the fourth image in steps 1031, 1032, 1031a, 1032a, and 1032a1, includes the following steps.

Step 1033a/step 1034a: performing first-level feature extraction on the third image and/or the fourth image to obtain the first-level feature of the to-be-recognized object.

Step 1035a1: calculating the first-level similarity between the first-level feature of the to-be-recognized object and the first-level feature of the current candidate object, taking the current candidate object whose first-level similarity meets the first matching condition as the candidate object matching the to-be-recognized object, taking the current candidate object whose first-level similarity meets the second matching condition as a candidate object not matching the to-be-recognized object, and taking the current candidate object whose first-level similarity meets the third matching condition as an alternative candidate object; and the current candidate object being one of the plurality of candidate objects.

Step 1035b: determining, in response to the current candidate object being a candidate object matching the to-be-recognized object, that the identity recognition result of the to-be-recognized object is the current candidate object, where step 1035 ends.

Step 1035c: taking a candidate object among the plurality of candidate objects that has not been taken as a current candidate object as the current candidate object, and executing step 1035a1 until all the candidate objects among the plurality of candidate objects have been taken as the current candidate object.

Step 1033b/step 1034b: performing secondary feature extraction on the third image and/or the fourth image to obtain the secondary feature of the to-be-recognized object.

Step 1035e: calculating the secondary similarity between the secondary feature of the to-be-recognized object and the secondary feature of at least some of the alternative candidate objects.

Step 1035f: determining, according to the secondary similarity, whether the alternative candidate object is a candidate object matching the to-be-recognized object.

According to some embodiments, the performing secondary feature extraction on the third image in step 1033b includes the following steps.

Step 1: processing the third image to obtain the to-be-recognized feature image.

The to-be-recognized feature image corresponding to the third image may be obtained by processing the third image, and the to-be-recognized feature image corresponding to the third image includes a plurality of feature lines capable of representing vein distribution of the to-be-recognized object. In this embodiment, the to-be-recognized feature image may be a binary image or a grayscale image, in which a white portion or a whitish portion represents a portion where the feature lines are located, and a black portion or a blackish portion represents a portion where no feature line exists. The above-described process may be implemented by a computational method, or may also be implemented by inputting the third image into a pre-trained vein recognition model and acquiring output thereof.

Step 2: extracting minutiae features in the to-be-recognized feature image.

Feature extraction is performed on the to-be-recognized feature image corresponding to the third image to obtain the corresponding minutiae features, and the above-described minutiae features may be, for example, features such as intersections of a plurality of veins, turning points of each vein, etc. The above-described minutiae feature extraction may be implemented by using a computational method or a neural network model.

In addition, it should be noted that, each candidate object also corresponds to a candidate feature image (each alternative candidate object also corresponds to an alternative feature image), and the minutiae feature of the candidate object may also be determined from the candidate feature image. A specific type of the minutiae feature of the candidate object is the same as the type of the minutiae feature of the to-be-recognized object, and no details will be repeated here. It should be understood that, the candidate database may not store candidate feature image, but only store the minutiae feature extracted from the candidate feature image.

According to some embodiments, the performing identity recognition based on the third image in step 103 includes performing identity recognition based on the third image and the fourth image, the fourth image is at least one image among the second images in which the to-be-recognized target is detected, and the method 100 further includes the following steps of determining the third image from the first image.

Step I: inputting the first image into a hand detecting neural network, and acquiring a detection result output by the hand detecting neural network, the detection result including a plurality of first palm key points of a palm in the first image, and an information degree of at least one region of the palm, and the at least one region being determined based on the plurality of first palm key points and/or palm contour lines.

Step II: determining, at least based on the plurality of first palm key points and/or the information degree of the at least one region corresponding to the first image, whether quality of the first image is qualified.

Step III: determining the third image from at least one qualified first image.

The second image may be similarly processed, and the fourth image may be determined from the second image.

The information degree of the palm may include, for example, at least one selected from a group consisting of: the number of palm prints, sharpness of palm prints, the number of palm veins, and sharpness of palm veins. The information degree represents the amount of information. The information degree will affect accuracy of a subsequent palm recognition result. It should be understood that, the greater the information degree, the greater the amount of information contained, the more the information that may be used for comparison, and the higher the accuracy of the recognition result. Therefore, the technical solutions according to the embodiments of the present disclosure are capable of judging whether the hand image is qualified or not according to the information degree of the palm.

In this way, the hand image may be quickly processed through a neural network, and the palm key point information and the information degree of at least one region of the palm in the hand image may be accurately and effectively output, so as to ensure that a sharp hand image having sufficient features may be obtained, and ensure quality of the image used for identity recognition.

According to some embodiments, the hand detecting neural network includes a backbone network and at least one sub-network connected with the backbone network, the at least one sub-network includes an information detecting sub-network, and may further include a palm contour detecting sub-network and a finger contour detecting sub-network, the to-be-processed hand image is input to the backbone network, and the output of the backbone network is respectively input to respective sub-networks. For example, in the case where the at least one sub-network includes an information detecting sub-network, a palm contour detecting sub-network and a finger contour detecting sub-network, the output of the backbone network is respectively input to the information detecting sub-network, the palm contour detecting sub-network and the finger contour detecting sub-network. The information detecting sub-network outputs a plurality of first palm key points of the palm and an information degree of at least one region of the palm, the palm contour detecting sub-network outputs a palm contour line, and the finger contour detecting sub-network outputs a finger contour line. In this case, the detection result further includes the palm contour line output by the palm contour detecting sub-network and the finger contour line output by the finger contour detecting sub-network. It should be understood that, the information detecting sub-network may include two parallel sub-networks, that is, a key point detecting network and an information degree detecting network.

Therefore, in the hand detecting neural network, the backbone network is provided in a shallow network, and is configured to execute general calculation and detection flow on the hand image. A plurality of branches of sub-networks are provided in a deep network of the neural network, and the respective sub-networks may share a calculation result of the backbone network and take the calculation result of the backbone network as the input of the respective sub-networks. In the respective sub-networks, calculation is performed in parallel according to their own requirements, and corresponding detection results are output respectively. Through the combination of the backbone network and the sub-networks, the utilization rate of computing resources and the computing speed of the neural network are improved.

It should be understood that, the hand detecting neural network is not limited to the above-described architecture, for example, the hand detecting neural network may not include the palm contour detecting sub-network and/or the finger contour detecting sub-network. That is, the palm contour line and/or the finger contour line may also be obtained by, for example, a general machine vision algorithm, or the palm contour line and/or the finger contour line may be obtained by a neural network that is obtained through independent training.

According to some embodiments, step II includes the following steps.

Step II1: determining, at least based on the plurality of first palm key points and/or the information degree of the at least one region corresponding to the first image, a quality index of the first image.

Step II2: determining, based on the quality index of the first image, whether quality of the first image is qualified.

The quality index includes at least one selected from a group consisting of: normalized information degree, palm integrity, palm inclination angle, and palm movement speed.

Whether quality of the second image is qualified may be determined in a similar manner.

According to some embodiments, in the case where the quality index includes the normalized information degree, the information degree of at least one region of the palm includes an information degree of a plurality of sub-regions in the palm region, and the palm region is determined by the palm contour line and/or a plurality of second palm key points. The determining, at least based on the plurality of second palm key points and/or the information degree of the at least one region, the quality index, includes: calculating, according to the information degree of the plurality of sub-regions, an overall information degree of the palm region, and dividing the overall information degree by the palm area to obtain the normalized information degree.

An information degree of each sub-region in the palm region may indicate the amount of information contained in the sub-region, specifically, may represent sharpness and quantity of biometric features contained in the sub-region, for example, sharpness and quantity of palm veins, and sharpness and quantity of palm prints.

According to some embodiments, the determining whether quality of the to-be-processed hand image is qualified includes: determining whether the normalized information degree is greater than an information degree threshold. The information degree threshold may include at least one selected from a group consisting of: a first sharpness threshold representing sharpness of palm veins, a first quantity threshold representing the number of palm veins, a second sharpness threshold representing sharpness of palm prints, and a second quantity threshold representing the number of palm prints.

According to some embodiments, the palm region may be determined based on the palm contour line and/or the plurality of second palm key points, and the determined palm region is divided into a plurality of sub-regions. Exemplarily, the dividing mode of the sub-regions may be, but not limited to, dividing the palm region into grids, for example, a 20×20 grid, where each grid corresponds to a sub-region. In this case, the determining the quality index may include: acquiring an information degree corresponding to each grid (i.e., sub-region) predicted and output by the hand detecting neural network; calculating the overall information degree of the palm region according to the information degree of the plurality of sub-regions; and dividing the overall information degree by the area of the palm region to obtain the normalized information degree.

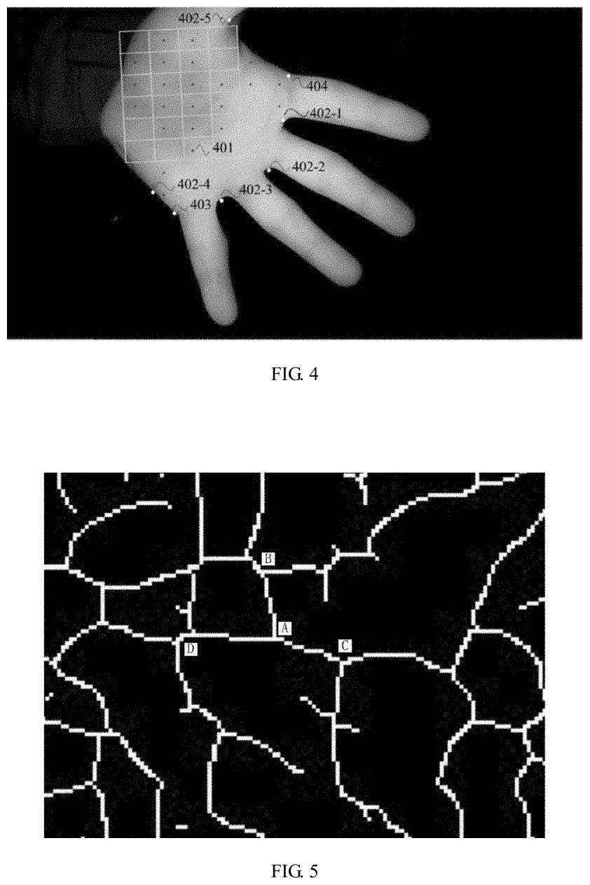

FIG. 4 shows a schematic diagram of the output result of the hand detecting neural network according to an exemplary embodiment of the present disclosure, a plurality of points 401 in FIG. 4 may be, for example, center points of the plurality of sub-regions respectively corresponding thereto, and the output of the hand detecting neural network further includes the information degree of each point 401 (not shown). In the example illustrated in FIG. 4, only center points 401 of a plurality of sub-regions whose information degree is greater than a preset threshold are shown. FIG. 4 further shows positions of palm key points 402-1 to 402-5. It should be understood that, FIG. 4 is only visual display of the output result of the hand detecting neural network, which does not mean that the output result of the hand detecting neural network must be in the form of FIG. 4. For example, the output result of the hand detecting neural network may be the coordinates of the center point and the information degree of the sub-region.

According to some embodiments, in the case where quality index includes palm integrity, the determining, at least based on the plurality of first palm key points and/or the information degree of the at least one region, the quality index, includes: determining palm integrity in the to-be-processed hand image in response to meeting at least one selected from a group consisting of: the number of the plurality of second palm key points is not less than a preset value, the plurality of second palm key points include key points of a second preset label, virtual key points determined based on the plurality of second palm key points are located in the to-be-processed hand image, abscissas and/or ordinates of the virtual key points determined based on the plurality of second palm key points in an image coordinate system where the to-be-processed hand image is located is within a preset coordinate range, and the distance between a lower edge of the palm contour line and a lower side edge of the to-be-processed hand image is greater than a second distance threshold; the plurality of second palm key points include a first outer end point of a root line of an index finger and a second outer end point of a root line of a little finger, the virtual key points are the other two vertices of a rectangle determined by taking the first outer end point and the second outer end point as two adjacent vertices of the rectangle, an aspect ratio of the rectangle meets a first ratio, and the other two vertices of the rectangle are located on a side of a line connecting the first outer end point and the second outer end point that is close to a centroid of the palm. Therefore, it is judged, based on the number of key points, whether specific key points are included, positions of the virtual key points, whether the aspect ratio of the palm meets a specific ratio, and whether the distance between the lower edge of the palm contour line and the lower side edge of the image is greater than a specific distance, whether the complete palm is included in the image, which can ensure that the qualified image includes the complete palm.

According to some embodiments, in the case where the quality index includes the palm inclination angle, the palm inclination angle is obtained by one of modes below: being predicted by the hand detecting neural network; being obtained based on the angular relationship between the plurality of second palm key points; being obtained based on a length ratio of a first connecting line to a second connecting line; and being obtained based on the aspect ratio of the palm region determined based on the plurality of second palm key points and/or the palm contour line. The first connecting line is a connecting line between a key point of a third preset label and a key point of a fourth preset label among the plurality of second palm key points, the second connecting line is a connecting line between a key point of a fifth preset label and a key point of a sixth preset label among the plurality of second palm key points, and both the first connecting line and the second connecting line are capable of representing the length or the width of the palm region. Thus, the inclination angle of the palm is calculated based on a geometric positional relationship of the palm key points.

According to some embodiments, in the case where the quality index includes the palm movement speed, the determining the quality index of the to-be-processed hand image further includes: determining, based on a plurality of first palm key points or a plurality of second palm key points in two or more video frames in a hand video, the palm movement speed.

In some embodiments, step II1 includes: processing the plurality of first palm key points corresponding to the first image to obtain the plurality of second palm key points corresponding to the first image, and determining, based on the second palm key points and/or the information degree of at least one region corresponding to the first image, the quality index of the first image.

As compared with the first palm key points, in the second palm key points, accurate key points can be added, inaccurate key points can be corrected, and redundant key points can be eliminated.

Hereinafter, how to process the plurality of first palm key points corresponding to the first image to obtain the plurality of second palm key points corresponding to the first image is described through three exemplary embodiments.

In an exemplary embodiment, the processing the plurality of first palm key points includes: determining, based on the plurality of first palm key points and/or the palm contour line, at least one anchor point, in which the plurality of second palm key points include the plurality of first palm key points and the at least one anchor point. For example, the centroid of the palm is determined based on the palm contour line, and with respect to each key point of the first preset label among the at least one key point of the first preset label, the intersection of a ray, which takes the key point of the first preset label as a starting point and passing through the centroid, and the palm contour line is determined as the anchor point. The key point of the first preset label may be a relatively accurate key point pre-determined, and based on each relatively accurate key point pre-determined, an anchor point corresponding thereto is determined, so as to reduce impact of inaccurate points on accuracy of the judgment result.

In an exemplary embodiment, the first image is the current video frame in the hand video, and the processing the plurality of first palm key points includes: acquiring, in response to it being determined that the number of the plurality of first palm key points is greater than a preset value, a plurality of reference key points of a palm in at least one previous video frame before the current video frame; affine transforming the plurality of first palm key points in the current video frame and the plurality of reference key points in the at least one previous video frame to reference frames, to obtain first transformation points respectively corresponding to the plurality of first palm key points and second transformation points respectively corresponding to the plurality of reference key points in each previous video frame; determining, with respect to each first transformation point, and in response to it being determined that distance between the first transformation point and the plurality of second transformation points in the at least one previous video frame that respectively correspond to the first transformation point is less than a first distance threshold, a first palm key point corresponding to the first transformation point as an accurate key point; and determining, according to the accurate key point, a second palm key point.

In an exemplary embodiment, the to-be-processed hand image is the current video frame in the hand video, and the processing the plurality of first palm key points includes: acquiring a plurality of reference key points of a palm in at least one previous video frame before the current video frame; updating, with respect to each first palm key point, and based on the position of the first palm key point and positions of at least one reference key point respectively corresponding to the first palm key point in the at least one previous video frame, the position of the first palm key point; and determining each first palm key point after position update as a second palm key point.

An embodiment of the present disclosure further provides a method 200 for performing identity recognition on a to-be-recognized object, applied to an electronic device, the electronic device includes an infrared camera and a visible light camera, and the method includes the following steps.

Step 201: acquiring, by the infrared camera, and in response to an infrared camera turn-on condition being met, a first image of a to-be-recognized target.

Step 202: acquiring, by the visible light camera, and in response to a visible light camera turn-on condition being met, a second image of the to-be-recognized target.

The corresponding parts of step 101 and step 102 may be referred to for description of step 201 and step 202.

Step 203: determining a third image from the first image, the third image being at least one image among the first image in which the to-be-recognized target is detected, and the to-be-recognized target being a finger and/or a palm.

Step 204: determining a fourth image from the second image, the fourth image being at least one image among the second image in which the to-be-recognized target is detected.

The description of step I to step III may be referred to for description of step 203 and step 204.

Step 205: performing feature extraction on the third image and/or the fourth image to obtain a first-level feature of the to-be-recognized object, and the first-level feature including a to-be-recognized feature vector.

Step 206: screening, based on the to-be-recognized feature vector, from a plurality of candidate objects in the candidate object database to obtain an alternative candidate object.

The to-be-recognized feature vector is obtained by performing feature extraction on the third image and/or the fourth image, and reflects a macroscopic or overall feature of the to-be-recognized object. The candidate object in the candidate database corresponds to the candidate feature vector. According to the distance between the to-be-recognized feature vector and the candidate feature vector, an alternative candidate object may be determined.

Step 207: processing the third image to obtain a to-be-recognized feature image, and the to-be-recognized feature image including a plurality of feature lines capable of representing palm vein distribution of the to-be-recognized target.

The description of step 1 may be referred to for description of step 207.

Step 208: calculating, based on at least one to-be-recognized feature image, a secondary similarity between the secondary feature of the to-be-recognized object and a secondary feature of at least some of the alternative candidate objects, and the secondary feature including the palm vein minutiae feature.

Step 208 includes: step 2081, extracting a minutiae feature in the to-be-recognized feature image (the description of step 2 may be referred to for description of step 2081) to obtain the palm vein minutiae feature of the to-be-recognized object; and step 2082: calculating, according to the palm vein minutiae feature of the to-be-recognized object, the secondary similarity between the secondary feature of the to-be-recognized object and the secondary feature of at least some alternative candidate objects (the description of step 1035e may be referred to for description of step 2082).

Step 209: determining, according to the secondary similarity, whether the alternative candidate object is a candidate object matching the to-be-recognized object.

The description of step 1035f may be referred to for description of step 209.

The to-be-recognized target is the hand of the to-be-recognized object.

The method according to this embodiment, firstly uses the to-be-recognized feature vector (a macroscopic feature) of the to-be-recognized image to preliminarily screen a plurality of candidate objects, and candidate objects having a greater difference from the to-be-recognized object are filtered out, which improves comparison efficiency and shortens time for matching. Then, a target object matching the to-be-recognized object is obtained based on the palm vein minutiae feature in the to-be-recognized feature image, so that the obtained matching screening result will be more reliable. The method according to this embodiment combines preliminary screening based on the to-be-recognized feature vector and fine matching based on the minutiae feature, which improves reliability of the matching screening result while improving screening efficiency.

According to some embodiments, the method 100 and the method 200 further include the following step.

Step 107: executing, in response to receiving a user's registration request, a registration operation.

The registration operation includes the following steps.

Step 1071: acquiring a coerced hand image of the user, and the coerced hand image including an infrared coerced hand image captured by an infrared camera and a visible light coerced hand image captured by a visible light camera.

Step 1072: extracting a coercion feature in the coerced hand image.

Step 1073: saving a candidate feature of a first candidate object corresponding to the user, and the candidate feature of the first candidate object including a normal feature and a coercion feature.

It may be understood that, before identity recognition by using the identity recognizing method, it is necessary to firstly enter palm information of the user or identifier code information corresponding to the user, so as to implement identity recognition and authentication by subsequent comparison between the information entered by the user and the captured image information.

In one example, when entering the palm information, the user may choose to enable an anti-coercion function, and enter a coerced hand image that is different from a normal hand image. The coerced hand and the normal hand may be different hands (e.g., a left hand for a normal state, a right hand for a coerced state), or may also be the same hand having different gestures (e.g., a hand with five fingers open for a coerced state, and a hand with five fingers close together for a normal state; a hand with five fingers stretching straight for a coerced state, and a hand with one finger bent for a normal state), or having different distances or angles to the camera.

Correspondingly, the performing identity recognition based on the third image, and determining the identity recognition result in step 103 not only include whether there is a candidate object matching the to-be-recognized object, which candidate object matches the to-be-recognized object, but also include whether the to-be-recognized object matches a normal feature of the candidate object or a coercion feature of the candidate object. The determining whether the alternative candidate object is a candidate object matching the to-be-recognized object in step 209 not only includes whether there is an alternative candidate object matching the to-be-recognized object, which alternative candidate object matches the to-be-recognized object, but also include whether the to-be-recognized object matches a normal feature of the alternative candidate object or a coercion feature of the alternative candidate object.

In this embodiment, during registration, the user is allowed to save a normal feature and a coercion feature for feature comparison and identity recognition; if the hand used by the user during identity recognition is a hand in a coerced state, then the feature for identity recognition extracted in the first image and the second image is compared with the coercion feature, so that whether the user is in a coerced state may be recognized without being perceived by a coercer, and corresponding security measures are taken to ensure security of the user, when it is determined that the user is coerced, thereby improving security performance of the identity recognizing method. Meanwhile, a combination of the infrared camera and the visible light camera may be used to capture the user's coerced hand image, and corresponding feature extraction is performed, so that the extracted hand coercion features are more abundant and complete, so as to improve accuracy of identity recognition and judgment of whether the user is coerced.

According to some embodiments, step 1071 includes the following steps.

Step 1071a: acquiring an initial coerced hand image of the user, and determining whether quality of the initial coerced hand image is qualified.

It should be understood that, before acquiring the initial coerced hand image of the user, the user may be given a prompt about requirements of the coerced hand image, for example, more than two fingers cannot be bent, or the entire palm needs to be shown, etc.

Step 1071b: taking, in response to quality of the initial coerced hand image being qualified, the initial coerced hand image as the coerced hand image of the user.

In one example, whether quality of the coerced hand image is qualified may be measured by the information degree (i.e., the amount of information contained in the image that may be used for identity recognition), for example, an information degree evaluation network model is used to determine whether the hand image information degree is sufficient for identity recognition.

In one example, it may be determined whether quality of the coerced hand image is qualified by detecting whether the coerced hand image contains a complete palm and at least N fingers.

Step 1071c: demonstrating, in response to quality of the initial coerced hand image being unqualified, an alternative gesture set, acquiring an alternative coerced hand image of the user, and taking the alternative coerced hand image as the coerced hand image of the user; and the gestures of the user's hand in the alternative coerced hand image being selected from the alternative gesture set.

During registration, firstly, the coerced hand image is set by the user; if the biometric features contained in the coerced hand image are too few to allow identity recognition (e.g., the coerced hand image set by the user is making a fist), the alternative gesture set will be supplied to the user, prompting the user to select a suitable gesture therefrom, and taking an image captured when the hand is in a selecting gesture as the coerced hand image.

According to another aspect of the present disclosure, an electronic device is further provided, including at least one processor, and a memory communicatively connected to the at least one processor. The memory stores instructions executable by the at least one processor, the instructions are capable of being executed by the at least one processor to enable the at least one processor to execute the above-mentioned identity recognizing method.

According to another aspect of the present disclosure, a non-transitory computer-readable storage medium storing computer instructions is further provided, and the computer instructions are configured to cause a computer to execute the above-mentioned identity recognizing method.

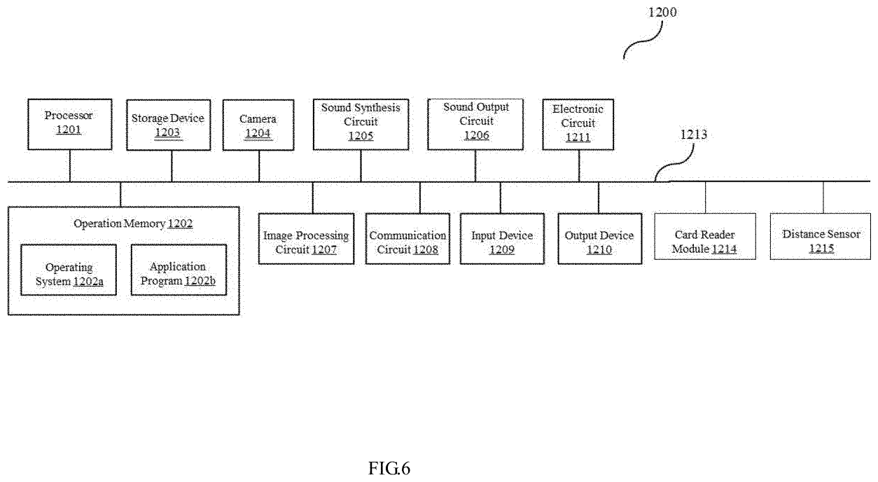

FIG. 6 is a block diagram showing an example of an electronic device according to an exemplary embodiment of the present disclosure. It should be noted that, the structure shown in FIG. 6 is only an example, and according to specific implementations, the electronic device according to the present disclosure may only include one or more of the components shown in FIG. 6.

The electronic device 1200 may be, for example, an edge device or a terminal device such as a general-purpose computer (e.g., various computers such as a laptop computer, a tablet computer, etc.), a mobile phone, a personal digital assistant, etc. According to some embodiments, the electronic device 1200 may be an access control device, a payment device, or an identity authentication device.

The electronic device 1200 may be configured to capture an image, process the captured image, and provide a voice prompt or a text prompt in response to data obtained from the processing. For example, the electronic device 1200 may be configured to capture an image, process the image to perform identity recognition based on a processing result, generate sound data based on a recognition result, and output the sound data to alert the user.

According to some implementations, the electronic device 1200 may be configured to include an access control device or a payment device, or be configured to be detachably mountable to an access control device or a payment device.

The electronic device 1200 may include a visible light camera and an infrared camera 1204 for acquiring an image. The camera 1204 may include, but is not limited to, a pick-up head or a pick-up camera, etc., and is configured to acquire an image including the to-be-recognized target. The electronic device may further include a card reader module 1214 and a distance sensor 1215. The card reader module may be an NFC module, and may be configured at the bottom of the screen to reduce the device volume. The electronic device 1200 may further include an electronic circuit 1211, and the electronic circuit 1211 includes a circuit configured to execute the steps of the method as previously described (e.g., the method steps shown in the flow chart of FIG. 1). The electronic device 1200 may further include a sound synthesis circuit 1205, and the sound synthesis circuit 1205 is configured to synthesize a prompting sound based on the identity recognition result. The sound synthesis circuit 1205 may be implemented by, for example, a dedicated chip. The electronic device 1200 may further include a sound output circuit 1206, and the sound output circuit 1206 is configured to output the sound data. The sound output circuit 1206 may include, but is not limited to, an earphone, a speaker, or a vibrator, etc., as well as driving circuits corresponding thereto.

According to some implementations, the electronic device 1200 may further include an image processing circuit 1207, and the image processing circuit 1207 may include a circuit configured to perform various image processing on an image. The image processing circuit 1207 may include, for example, but is not limited to, one or more of the following: a circuit configured to denoise an image, a circuit configured to deblur an image, a circuit configured to geometrically correct an image, a circuit configured to preprocess an image, a circuit configured to perform feature extraction on an image, a circuit configured to perform object detection and/or recognition of an object in an image, etc.

One or more of the above-described various circuits (e.g., the sound synthesis circuit 1205, the sound output circuit 1206, the image processing circuit 1207, and the electronic circuit 1211) may be implemented by custom hardware, and/or may be implemented by hardware, software, firmware, middleware, microcode, hardware description language or any combination thereof. For example, one or more of the above-described various circuits may be implemented by programming hardware (e.g., a programmable logic circuit including Field Programmable Gate Array (FPGA) and/or Programmable Logic Array (PLA)) in an assembly language or a hardware programming language (e.g., VERILOG, VHDL, C++) according to the logic and the algorithm according to the present disclosure.

According to some implementations, the electronic device 1200 may further include a communication circuit 1208, and the communication circuit 1208 may be any type of device or system capable of communicating with external devices and/or with a network, and may include, but is not limited to, a modem, a network card, an infrared communication device, a wireless communication device and/or a chipset, for example, a Bluetooth device, a 802.11 device, a WiFi device, a WiMax device, a cellular communication device and/or the like.

According to some implementations, the electronic device 1200 may further include an input device 1209, and the input device 1209 may be any type of device capable of inputting information to the electronic device 1200, and may include, but is not limited to, various sensors, mouses, keyboards, touch screens, buttons, joysticks, microphones and/or remote controls, etc.

According to some implementations, the electronic device 1200 may further include an output device 1210, and the output device 1210 may be any type of device capable of presenting information, and may include, but is not limited to, a display, a visual output terminal, a vibrator, and/or a printer, etc. Although the electronic device 1200, according to some embodiments, is used in a visually impaired assistive device, a vision-based output device may facilitate the user's family members or maintenance personnel, etc. to obtain output information from the electronic device 1200.

According to some implementations, the electronic device 1200 may further include a processor 1201. The processor 1201 may be any type of processor, and may include, but is not limited to, one or more general-purpose processors and/or one or more special-purpose processors (e.g., special processing chips). The processor 1201 may be, for example, but not limited to, a Central Processing Unit (CPU) or a Microprocessor unit (MPU), etc. The electronic device 1200 may further include an operation memory 1202, the operation memory 1202 may be an operation memory that stores programs (including instructions) and/or data (e.g., images, texts, sounds, and other intermediate data, etc.) useful for operation of processor 1201, and may include, but is not limited to, a random access memory and/or a read only memory device. The electronic device 1200 may further include a storage device 1203, the storage device 1203 may include any non-transitory storage device, and the non-transitory storage device may be any storage device that is non-transitory and that is capable of storing data, and may include, but is not limited to a disk drive, an optical storage device, a solid-state memory, a floppy disk, a flexible disk, a hard disk, a magnetic tape or any other magnetic medium, an optical disc or any other optical medium, a Read Only Memory (ROM), a Random Access Memory (RAM), a cache memory and/or any other memory chip or cartridge, and/or any other medium from which a computer may read data, instructions and/or code. The operation memory 1202 and the storage device 1203 may be collectively referred to as “memory” and may be used concurrently with each other in some cases.

According to some implementations, the processor 1201 may control and schedule at least one of the camera 1204, the sound synthesis circuit 1205, the sound output circuit 1206, the image processing circuit 1207, the communication circuit 1208, the electronic circuit 1211, and other various devices and circuits included in the electronic device 1200. According to some implementations, at least some of the respective components as described in FIG. 6 may be in connection and/or communication with each other via a bus 1213.

Software elements (programs) may reside in the operation memory 1202, including but not limited to an operating system 1202a, one or more application programs 1202b, a driver, and/or other data and code.

According to some implementations, instructions for performing the above-described control and scheduling may be included in the operating system 1202a or one or more application programs 1202b.

According to some implementations, instructions for executing the method steps as described in the present disclosure (e.g., the method steps shown in the flow chart of FIG. 1) may be included in one or more application programs 1202b, and the respective modules of the above-described electronic device 1200 may be implemented by reading and executing instructions of one or more application programs 1202b by the processor 1201. In other words, the electronic device 1200 may include a processor 1201 and a memory (e.g., the operation memory 1202 and/or the storage device 1203) storing programs, the programs include instructions, and when executed by the processor 1201, the instructions cause the processor 1201 to execute the methods according to respective embodiments of the present disclosure.

According to some implementations, some or all of the operations performed by at least one of the sound synthesis circuit 1205, the sound output circuit 1206, the image processing circuit 1207, the communication circuit 1208, and the electronic circuit 1211 may be implemented by the processor 1201 reading and executing instructions of one or more application programs 1202.

The executable code or source code of the instructions of the software elements (programs) may be stored in a non-transitory computer-readable storage medium (e.g., the storage device 1203), and when executed, may be stored in the operation memory 1201 (probably for compilation or installation). Accordingly, the present disclosure provides a computer-readable storage medium for storing a program, the program includes instructions that, when executed by the processor of the electronic device (e.g., the visually impaired assistive device), cause the electronic device to execute the methods according to respective embodiments of the present disclosure. According to another implementation, the executable code or source code of the instructions of the software elements (programs) may also be downloaded from a remote location.

It should also be understood that, various modifications may be made according to specific requirements. For example, the respective circuits, units, modules, or elements may be implemented by custom hardware, and/or may also by hardware, software, firmware, middleware, microcode, hardware description languages, or any combination thereof. For example, some or all of the circuits, units, modules or elements included by the methods and the devices disclosed may be implemented by programming hardware (e.g., a programmable logic circuit including Field Programmable Gate Array (FPGA) and/or Programmable Logic Array (PLA)) in an assembly language or a hardware programming language (e.g., VERILOG, VHDL, C++) according to the logic and the algorithm according to the present disclosure.

According to some implementations, the processor 1201 in the electronic device 1200 may be distributed over a network. For example, some processing may be executed by one processor; and meanwhile, other processing may be executed by another processor remote from the one processor. Other modules of the electronic device 1200 may be similarly distributed. As such, the electronic device 1200 may be interpreted as a distributed computing system that executes processing in a plurality of locations.

Although the embodiments or examples of the present disclosure have been described with reference to the drawings, it should be understood that, the above-described methods, systems and devices are merely exemplary embodiments or examples, and the scope of the present disclosure is not limited by these embodiments or examples, but is limited only by the claims and equivalents thereof. Respective elements according to the embodiments or examples may be omitted or replaced by equivalents thereof. Furthermore, the respective steps may be executed in an order different from that described in the present disclosure. Further, the respective elements according to the embodiments or examples may be combined in various ways. Importantly, as technology evolves, many of the elements described herein may be replaced by equivalent elements that appear later in the present disclosure.

What is claimed is:

1. A method for performing identity recognition on a to-be-recognized object, applied to an electronic device, wherein the electronic device comprises an infrared camera and a visible light camera, and the method comprises:
acquiring, by the infrared camera, and in response to an infrared camera turn-on condition being met, a first image of a to-be-recognized target, and performing target detection on the first image, the to-be-recognized target being a finger and/or a palm;
acquiring, by the visible light camera, and in response to a visible light camera turn-on condition being met, a second image of the to-be-recognized target, and performing identifier code recognition on the second image;
performing, in response to the to-be-recognized target being detected from the first image, identity recognition based on a third image, and determining an identity recognition result of the to-be-recognized object, the third image being at least one image among the first image in which the to-be-recognized target is detected, and the identity recognition result determined based on the third image comprising a candidate object in a candidate database matching the to-be-recognized object; and
determining, in response to the identifier code being recognized, and according to an identifier code recognition result, the identity recognition result of the to-be-recognized object, and turning off at least one camera in an ON state,
wherein the to-be-recognized target is a hand or an identifier code of the to-be-recognized object.

2. The method according to claim 1, wherein the electronic device further comprises a card reader module, and the method further comprises:
determining, in response to the card reader module detecting a card signal of the to-be-recognized object, and according to the card signal, the identity recognition result of the to-be-recognized object, and turning off the at least one camera in an ON state.

3. The method according to claim 1, wherein the electronic device further comprises a distance sensor, and the acquiring, by the visible light camera, and in response to the visible light camera turn-on condition being met, the second image of the to-be-recognized target, and performing identifier code recognition on the second image, comprises:
acquiring, by the visible light camera, and in response to the visible light camera turn-on condition being met, the second image of the to-be-recognized target, performing identifier code recognition on the second image, and performing target detection on the second image, the to-be-recognized target being a finger and/or a palm;
the visible light camera turn-on condition is that the distance sensor detects the to-be-recognized target, and the infrared camera turn-on condition is that the to-be-recognized target is detected in the second image;
the performing, in response to the to-be-recognized target being detected from the first image, identity recognition based on the third image, comprises:
performing, in response to the to-be-recognized target being detected from the first image, identity recognition based on the third image and a fourth image, and the fourth image being at least one image among the second image in which the to-be-recognized target is detected.

4. The method according to claim 3, wherein,
the acquiring, by the visible light camera, and in response to the visible light camera turn-on condition being met, the second image of the to-be-recognized target, performing identifier code recognition on the second image, and performing target detection on the second image, comprises: acquiring, by the visible light camera, and under a first visible light supplementation condition, the second image of the to-be-recognized target, performing identifier code recognition on the second image captured under the first visible light supplementation condition, and performing target detection on the second image captured under the first visible light supplementation condition;
the method further comprises: capturing, by the visible light camera, and in response to the to-be-recognized target being detected from the second image captured under the first visible light supplementation condition with a confidence greater than a first confidence threshold, the second image under a second visible light supplementation condition, and performing target detection on the second image captured under the second visible light supplementation condition;
the acquiring, by the infrared camera, in response to the infrared camera turn-on condition being met, the first image of a to-be-recognized target, and performing target detection on the first image, comprises: acquiring, by the infrared camera, in response to the to-be-recognized target being detected from the second image captured under the first visible light supplementation condition with a confidence greater than the first confidence threshold, the first image of the to-be-recognized target, and performing target detection on the first image; and
the performing, in response to the to-be-recognized target being detected from the first image, identity recognition based on the third image and the fourth image, and the fourth image being at least one image among the second image in which the to-be-recognized target is detected, comprises: performing, in response to the to-be-recognized target being detected from the first image with a confidence greater than a second confidence threshold, identity recognition based on the third image and the fourth image, the fourth image being at least one image among the second image in which the to-be-recognized target is detected with a confidence greater than the second confidence threshold, and captured under the second visible light supplementation condition, and the second confidence threshold being higher than the first confidence threshold.

5. The method according to claim 1, wherein the electronic device further comprises a distance sensor, and the infrared camera turn-on condition and the visible light camera turn-on condition are that the distance sensor detects the to-be-recognized target;
the performing, in response to the to-be-recognized target being detected from the first image, identity recognition based on the third image, comprises:
no longer performing, in response to the to-be-recognized target being detected from the first image, identifier code recognition on the second image, and performing target detection on the second image, the to-be-recognized target being a finger and/or a palm; and performing, in response to the to-be-recognized target being detected from the second image, identity recognition based on the third image and a fourth image, the fourth image being at least one image from the second image in which the to-be-recognized target is detected.

6. The method according to claim 5, wherein acquiring, by the visible light camera, and in response to the visible light camera turn-on condition being met, the second image of the to-be-recognized target, comprises:
capturing, by the visible light camera, and in response to the visible light camera turn-on condition being met, the second image under a first visible light supplementation condition;
the no longer performing, in response to the to-be-recognized target being detected from the first image, identifier code recognition on the second image, and performing target detection on the second image, comprises:
capturing, by the visible light camera, in response to the to-be-recognized target being detected from the first image, the second image under a second visible light supplementation condition, no longer performing identifier code recognition on the second image captured under the second visible light supplementation condition, and performing target detection on the second image captured under the second visible light supplementation condition; and a light supplementation intensity of the second visible light supplementation condition being greater than a light supplementation intensity of the first visible light supplementation condition;
the performing, in response to the to-be-recognized target being detected from the second image, identity recognition based on the third image and the fourth image, comprises:
performing, in response to the to-be-recognized target being detected from the second image captured under the second visible light supplementation condition, identity recognition based on the third image and the fourth image, and the four image being at least one image among the second image captured under the second visible light supplementation condition in which the to-be-recognized target is detected.

7. The method according to claim 6, wherein the capturing, by the visible light camera, in response to the to-be-recognized target being detected from the first image, the second image under the second visible light supplementation condition, no longer performing identifier code recognition on the second image captured under the second visible light supplementation condition, and performing target detection on the second image captured under the second visible light supplementation condition, comprises:
capturing, by the visible light camera, and in response to the to-be-recognized target being detected from the first image with a confidence greater than a first confidence threshold, the second image under the second visible light supplementation condition, and performing identifier code recognition on the second image captured under the second visible light supplementation condition; no longer performing, in response to the target being detected from the first image with a confidence greater than a second confidence threshold, identifier code recognition on the second image captured under the second visible light supplementation condition, and performing target detection on the second image captured under the second visible light supplementation condition; and the light supplementation intensity of the second visible light supplementation condition being greater than the light supplementation intensity of the first visible light supplementation condition, and the second confidence threshold being greater than the first confidence threshold.

8. The method according to claim 3, wherein the performing the identity recognition based on the third image and the fourth image, comprises:
performing feature extraction on the third image to obtain an infrared feature of the to-be-recognized object;
performing feature extraction on the fourth image to obtain a visible light feature of the to-be-recognized object; and
performing identity recognition according to the infrared feature of the to-be-recognized object, the visible light feature of the to-be-recognized object, an infrared feature of the candidate object, and a visible light feature of the candidate object,
wherein the infrared feature comprises at least one selected form a group consisting of: a palm vein global feature, a palm vein minutiae feature, and a finger vein global feature; the visible light feature comprises a palm print global feature; and the candidate database comprises a plurality of candidate objects, each of the plurality of candidate objects has an infrared feature and a visible light feature corresponding thereto, the infrared feature of the candidate object is obtained by performing feature extraction on the infrared image of the candidate object, and the visible light feature of the candidate object is obtained by performing feature extraction on the visible light image of the candidate object.

9. The method according to claim 8, wherein the performing identity recognition according to the infrared feature of the to-be-recognized object, the visible light feature of the to-be-recognized object, the infrared feature of the candidate object, and the visible light feature of the candidate object, comprises:
a screening step: calculating a first-level similarity between a first-level feature of the to-be-recognized object and a first-level feature of a current candidate object, taking the current candidate object whose first-level similarity meets a first matching condition as a candidate object matching the to-be-recognized object, taking the current candidate object whose first-level similarity meets a second matching condition as a candidate object not matching the to-be-recognized object, and the current candidate object being one of the plurality of candidate objects;
a result determination step: determining, in response to the current candidate object being the candidate object matching the to-be-recognized object, that the identity recognition result of the to-be-recognized object is the current candidate object, where identity recognition ends;
a current candidate object determination step: taking a candidate object among the plurality of candidate objects that has not been taken as a current candidate object as the current candidate object; and
re-executing the screening step, the result determination step and the current candidate determination step, until all the candidate objects among the plurality of candidate objects have been taken as the current candidate object,
wherein the first-level feature comprises at least one selected from a group consisting of: the palm vein global feature, the finger vein global feature, the palm print global feature, and a fusion feature, and the fusion feature is obtained by fusing at least two selected from a group consisting of: the palm vein global feature, the finger vein global feature, and the palm print global feature.

10. The method according to claim 9, wherein the screening step further comprises:
taking the current candidate object whose first-level similarity meets a third matching condition as at least one alternative candidate object;
the method further comprises:
calculating, in response to all the candidate objects among the plurality of candidate objects having been taken as the current candidate object and no candidate object matching the to-be-recognized object being determined, a secondary similarity between a secondary feature of the to-be-recognized object and a secondary feature of at least some of the alternative candidate object; and
determining, according to the secondary similarity, whether the alternative candidate object is a candidate object matching the to-be-recognized object,
wherein the secondary feature comprises at least one selected from a group consisting of: the palm vein global feature, the finger vein global feature, the palm print global feature, and the palm vein minutiae feature, the fusion feature that are different from the first-level feature.

11. The method according to claim 10, wherein the performing feature extraction on the third image and performing feature extraction on the fourth image, comprises:
performing at least part of first-level feature extraction on the third image and/or the fourth image to obtain at least part of the first-level feature of the to-be-recognized object; and
performing, in response to all the candidate objects among the plurality of candidate objects having been taken as the current candidate object and no candidate object matching the to-be-recognized object being determined, secondary feature extraction on the third image and/or the fourth image to obtain the secondary feature of the to-be-recognized object.

12. The method according to claim 5, wherein the performing the identity recognition based on the third image and the fourth image, comprises:
performing feature extraction on the third image to obtain an infrared feature of the to-be-recognized object;
performing feature extraction on the fourth image to obtain a visible light feature of the to-be-recognized object; and
performing identity recognition according to the infrared feature of the to-be-recognized object, the visible light feature of the to-be-recognized object, an infrared feature of the candidate object, and a visible light feature of the candidate object,
wherein the infrared feature comprises at least one selected form a group consisting of: a palm vein global feature, a palm vein minutiae feature, and a finger vein global feature; the visible light feature comprises a palm print global feature; and the candidate database comprises a plurality of candidate objects, each of the plurality of candidate objects has an infrared feature and a visible light feature corresponding thereto, the infrared feature of the candidate object is obtained by performing feature extraction on the infrared image of the candidate object, and the visible light feature of the candidate object is obtained by performing feature extraction on the visible light image of the candidate object.

13. The method according to claim 12, wherein the performing identity recognition according to the infrared feature of the to-be-recognized object, the visible light feature of the to-be-recognized object, the infrared feature of the candidate object, and the visible light feature of the candidate object, comprises:
a screening step: calculating a first-level similarity between a first-level feature of the to-be-recognized object and a first-level feature of a current candidate object, taking the current candidate object whose first-level similarity meets a first matching condition as a candidate object matching the to-be-recognized object, taking the current candidate object whose first-level similarity meets a second matching condition as a candidate object not matching the to-be-recognized object, and the current candidate object being one of the plurality of candidate objects;
a result determination step: determining, in response to the current candidate object being the candidate object matching the to-be-recognized object, that the identity recognition result of the to-be-recognized object is the current candidate object, where identity recognition ends;
a current candidate object determination step: taking a candidate object among the plurality of candidate objects that has not been taken as a current candidate object as the current candidate object; and
re-executing the screening step, the result determination step and the current candidate determination step, until all the candidate objects among the plurality of candidate objects have been taken as the current candidate object,
wherein the first-level feature comprises at least one selected from a group consisting of: the palm vein global feature, the finger vein global feature, the palm print global feature, and a fusion feature, and the fusion feature is obtained by fusing at least two selected from a group consisting of: the palm vein global feature, the finger vein global feature, and the palm print global feature.

14. The method according to claim 13, wherein the screening step further comprises:
taking the current candidate object whose first-level similarity meets a third matching condition as at least one alternative candidate object;
the method further comprises:
calculating, in response to all the candidate objects among the plurality of candidate objects having been taken as the current candidate object and no candidate object matching the to-be-recognized object being determined, a secondary similarity between a secondary feature of the to-be-recognized object and a secondary feature of at least some of the alternative candidate object; and
determining, according to the secondary similarity, whether the alternative candidate object is a candidate object matching the to-be-recognized object,
wherein the secondary feature comprises at least one selected from a group consisting of: the palm vein global feature, the finger vein global feature, the palm print global feature, and the palm vein minutiae feature, the fusion feature that are different from the first-level feature.

15. The method according to claim 14, wherein
the secondary feature comprises the palm vein minutiae feature, and the palm vein minutiae feature comprises a plurality of target intersections between a plurality of feature lines representing palm vein distribution of the to-be-recognized object, and related parameters of each of the plurality of target intersections; the related parameters comprise at least one selected from a group consisting of: a position of a target intersection in a to-be-recognized feature image, a direction of a feature line, where the target intersection is located, at the target intersection, a spacing between the target intersection and an adjacent target intersection, an angle of a connecting line between the target intersection and the adjacent target intersection, a position of the adjacent target intersection of the target intersection in the to-be-recognized feature image, and a direction of a feature line, where the adjacent target intersection is located, at the adjacent target intersection;
the to-be-recognized feature image is obtained by processing the third image, and the to-be-recognized feature image comprises a plurality of feature lines capable of representing palm vein distribution of the to-be-recognized object; the alternative candidate object corresponds to an alternative feature image, the alternative feature image is obtained by processing an infrared image of the alternative candidate object, and the alternative feature image comprises a plurality of feature lines capable of representing palm vein distribution of the alternative candidate object;
the calculating the secondary similarity between the secondary feature of the to-be-recognized object and the secondary feature of at least some of the alternative candidate object, comprises:
selecting at least one of a plurality of target intersections corresponding to the to-be-recognized feature image as an initial point;
determining a maximum matching connectivity graph based on the initial point, and each target intersection included in the maximum matching connectivity graph has a matching intersection in the alternative feature image, wherein the matching intersection is a point among alternative intersections matching the target intersection, the alternative intersections are intersections between a plurality of feature lines that represents palm vein distribution of the alternative candidate object, and whether the target intersection matches the alternative intersections is determined according to the related parameters of the target intersection and the alternative intersections; and
determining the secondary similarity between the to-be-recognized object and the alternative candidate object according to a matching score corresponding to at least one maximum matching connectivity graph.

16. The method according to claim 15, wherein the determining the maximum matching connectivity graph based on the initial point, comprises:
judging, based on a related parameter of the initial point, whether there is a candidate intersection matching the initial point in the alternative feature image;
determining, in response to there being a matching candidate intersection, at least one adjacent target intersection adjacent to the initial point among the plurality of target intersections;
judging, based on a related parameter of each adjacent target intersection, whether a candidate intersection corresponding to the adjacent target intersection in the alternative feature image is a matching intersection of the adjacent target intersection;
taking, in response to it being determined that the candidate intersection corresponding to the adjacent target intersection in the alternative feature image is the matching intersection of the adjacent target intersection, the adjacent target intersection as a new initial point; and
repeating the above-described steps, until it is determined that there is no candidate intersection matching the adjacent target intersection, so as to obtain the maximum matching connectivity graph comprising the target intersections corresponding to all previous matching intersections.

17. The method according to claim 14, wherein the performing feature extraction on the third image and performing feature extraction on the fourth image, comprises:
performing at least part of first-level feature extraction on the third image and/or the fourth image to obtain at least part of the first-level feature of the to-be-recognized object; and
performing, in response to all the candidate objects among the plurality of candidate objects having been taken as the current candidate object and no candidate object matching the to-be-recognized object being determined, secondary feature extraction on the third image and/or the fourth image to obtain the secondary feature of the to-be-recognized object.

18. The method according to claim 1, wherein the performing identity recognition based on the third image, comprises: performing identity recognition based on the third image and a fourth image, and the fourth image being at least one image among the second image in which the to-be-recognized target is detected;
the method further comprises:
inputting the first image into a hand detecting neural network, and acquiring a detection result output by the hand detecting neural network, wherein the detection result comprises a plurality of first palm key points of a palm in the first image and an information degree of at least one region of the palm, and the at least one region of the first image is determined based on the plurality of first palm key points and/or palm contour lines of the first image;
determining, at least based on the plurality of first palm key points and/or the information degree of the at least one region corresponding to the first image, whether quality of the first image is qualified;
determining the third image from at least one qualified first image;
inputting the second image into the hand detecting neural network, and acquiring a detection result output by the hand detecting neural network, wherein the detection result comprises a plurality of first palm key points of a palm in the second image and an information degree of at least one region of the palm, and the at least one region of the second image is determined based on the plurality of first palm key points and/or palm contour lines of the second image;
determining, at least based on the plurality of first palm key points and/or the information degree of the at least one region corresponding to the second image, whether quality of the second image is qualified; and
determining the fourth image from at least one qualified second image.

19. The method according to claim 18, wherein the determining, at least based on the plurality of first palm key points and/or the information degree of the at least one region corresponding to the first image, whether quality of the first image is qualified, comprises:
determining, at least based on the plurality of first palm key points and/or the information degree of the at least one region corresponding to the first image, a quality index of the first image; and
determining, based on the quality index of the first image, whether quality of the first image is qualified;
the determining, at least based on the plurality of first palm key points and/or the information degree of the at least one region corresponding to the second image, whether quality of the second image is qualified, comprises:
determining, at least based on the plurality of first palm key points and/or the information degree of the at least one region corresponding to the second image, a quality index of the second image; and
determining, based on the quality index of the second image, whether quality of the second image is qualified,
wherein the quality index comprises at least one selected from a group consisting of: normalized information degree, palm integrity, palm inclination angle, and palm movement speed.

20. An electronic device, comprising:
at least one processor; and
a memory communicatively connected to the at least one processor, wherein
the memory stores instructions executable by the at least one processor, the instructions are capable of being executed by the at least one processor to enable the at least one processor to execute a method for performing identity recognition on a to-be-recognized object, and the method comprises:
acquiring, by an infrared camera, and in response to an infrared camera turn-on condition being met, a first image of a to-be-recognized target, and performing target detection on the first image, the to-be-recognized target being a finger and/or a palm;
acquiring, by a visible light camera, and in response to a visible light camera turn-on condition being met, a second image of the to-be-recognized target, and performing identifier code recognition on the second image;
performing, in response to the to-be-recognized target being detected from the first image, identity recognition based on a third image, and determining an identity recognition result of the to-be-recognized object, the third image being at least one image among the first image in which the to-be-recognized target is detected, and the identity recognition result determined based on the third image comprising a candidate object in a candidate database matching the to-be-recognized object;
determining, in response to the identifier code being recognized, and according to an identifier code recognition result, the identity recognition result of the to-be-recognized object, and turning off at least one camera in an ON state,
wherein, the to-be-recognized target is a hand or an identifier code of the to-be-recognized object.

21. A non-transitory computer-readable storage medium storing computer instructions, wherein the computer instructions are configured to cause a computer to execute a method for performing identity recognition on a to-be-recognized object, and the method comprises:
acquiring, by an infrared camera, and in response to an infrared camera turn-on condition being met, a first image of a to-be-recognized target, and performing target detection on the first image, the to-be-recognized target being a finger and/or a palm;
acquiring, by a visible light camera, and in response to a visible light camera turn-on condition being met, a second image of the to-be-recognized target, and performing identifier code recognition on the second image;
performing, in response to the to-be-recognized target being detected from the first image, identity recognition based on a third image, and determining an identity recognition result of the to-be-recognized object, the third image being at least one image among the first image in which the to-be-recognized target is detected, and the identity recognition result determined based on the third image comprising a candidate object in a candidate database matching the to-be-recognized object;
determining, in response to the identifier code being recognized, and according to an identifier code recognition result, the identity recognition result of the to-be-recognized object, and turning off at least one camera in an ON state,
wherein the to-be-recognized target is a hand or an identifier code of the to-be-recognized object.
